(19) United States
(12) Patent Application Publication
(10) Pub. No.: US 2026/0075659 A1
(43) Pub. Date: Mar. 12, 2026

(54) SWITCHING METHOD, CONFIGURATION METHOD, RANDOM ACCESS PROCESSING METHOD, AND DEVICE

(71) Applicant: VIVO MOBILE COMMUNICATION CO., LTD., Dongguan (CN)

(72) Inventor: Li CHEN, Dongguan (CN)

(21) Appl. No.: 19/390,709

(22) Filed: Nov. 17, 2025

Related U.S. Application Data
(63) Continuation of application No. PCT/CN2024/092131, filed on May 10, 2024.

(30) Foreign Application Priority Data
May 17, 2023 (CN) 202310557709.0

(51) Int. Cl. H04W 74/0836; H04W 72/23

(52) U.S. Cl. CPC H04W 74/0836; H04W 72/23

(57) ABSTRACT

A switching method, a configuration method, a random access processing method, and a device are provided. The switching method includes: a terminal performing a first operation in a case that a first BWP satisfies a first condition, where the first condition includes at least one of: a target configuration on the first BWP does not match a capability of the terminal, no 4-step random access is configured on the first BWP, and a random access failure occurs, where the target configuration includes at least one of: a random access channel RACH resource and a monitoring configuration for a downlink channel; and the first operation includes: switching to a second BWP; or initiating random access or monitoring the downlink channel on the second BWP; or on the first BWP, performing a 4-step random access procedure or monitoring a downlink channel corresponding to the 4-step random access procedure.

### CROSS-REFERENCE TO RELATED APPLICATIONS

This application is a continuation of International Patent Application No. PCT/CN2024/092131, filed on May 10, 2024, which claims priority to Chinese Patent Application No. 202310557709.0 filed in China on May 17, 2023, both of which are incorporated herein by reference in their entireties.

### TECHNICAL FIELD

This application relates to the field of communication technologies, and specifically, to a switching method, a configuration method, a random access processing method, and a device.

### BACKGROUND

Some communication systems support 2-step random access and 4-step random access. However, in some related technologies, only one type of random access is usually configured for some bandwidth parts (Bandwidth Parts, BWPs), or a configured random access channel (Random Access Channel, RACH) resource or a monitoring configuration for a downlink channel does not match a capability of a terminal.

### SUMMARY

Embodiments of this application provide a switching method, a configuration method, a random access processing method, and a device.

According to a first aspect, a switching method is provided, including:
A terminal performs a first operation in a case that a first BWP satisfies a first condition, where the first condition includes at least one of the following: a target configuration on the first BWP does not match a capability of the terminal, no 4-step random access is configured on the first BWP, or a random access failure occurs, where the target configuration includes at least one of the following: a random access channel RACH resource or a monitoring configuration for a downlink channel; and
the first operation includes:
switching to the second BWP; or
initiating random access or monitoring the downlink channel on the second BWP; or
on the first BWP, performing a 4-step random access procedure or monitoring a downlink channel corresponding to the 4-step random access procedure, where the first condition is that the target configuration on the first BWP does not match the capability of the terminal.

According to a second aspect, a configuration method is provided, including:

A network side device sends configuration information to a terminal, where
the configuration information is used for, in a case that a network side configures 2-step random access on a first bandwidth part BWP, configuring 4-step random access for the first BWP; or
configuration content that the configuration information is used for satisfies at least one of the following:
a RACH resource corresponding to the 2-step random access configured on the first BWP matches a capability of the terminal;
a monitoring configuration for a downlink channel that corresponds to the 2-step random access configured on the first BWP matches the capability of the terminal;
a RACH resource corresponding to the 4-step random access configured on the first BWP matches the capability of the terminal; or
a monitoring configuration for the downlink channel that corresponds to the 4-step random access configured on the first BWP matches the capability of the terminal.

According to a third aspect, a random access processing method is provided, including:

A terminal performs a target operation on a target BWP, where the target operation includes at least one of the following:
in a case that 2-step random access is configured on the target BWP, selecting or performing the 2-step random access, or confirming that the 2-step random access is available;
in a case that 4-step random access is configured on the target BWP, selecting or performing the 4-step random access, or confirming that the 4-step random access is available;
in a case that the 2-step random access and the 4-step random access are configured on the target BWP, selecting or performing the 2-step random access, or confirming that the 2-step random access is available; or in the case that the 2-step random access and the 4-step random access are configured on the target BWP, selecting or performing the 4-step random access, or confirming that the 4-step random access is available.

According to a fourth aspect, a switching apparatus is provided, including:
a first execution module, configured to perform a first operation in a case that a first bandwidth part BWP satisfies a first condition, where the first condition includes at least one of the following: a target configuration on the first BWP does not match a capability of the terminal, no 4-step random access is configured on the first BWP, or a random access failure occurs, where the target configuration includes at least one of the following: a random access channel RACH resource or a monitoring configuration for a downlink channel; and
the first operation includes:
switching to the second BWP; or
initiating random access or monitoring the downlink channel on the second BWP; or
on the first BWP, performing a 4-step random access procedure or monitoring a downlink channel corresponding to the 4-step random access procedure, where the first condition is that the target configuration on the first BWP does not match the capability of the terminal.

According to a fifth aspect, a configuration apparatus is provided, including:
a sending module, configured to send configuration information to a terminal, where
the configuration information is used for, in a case that a network side configures 2-step random access on a first bandwidth part BWP, configuring 4-step random access for the first BWP; or
configuration content that the configuration information is used for satisfies at least one of the following:
a RACH resource corresponding to the 2-step random access configured on the first BWP matches a capability of the terminal;
a monitoring configuration for a downlink channel that corresponds to the 2-step random access configured on the first BWP matches the capability of the terminal;
a RACH resource corresponding to the 4-step random access configured on the first BWP matches the capability of the terminal; or
a monitoring configuration for the downlink channel that corresponds to the 4-step random access configured on the first BWP matches the capability of the terminal.

According to a sixth aspect, a random access processing apparatus is provided, including:
an execution module, configured to perform a target operation on a target BWP, where the target operation includes at least one of the following:
in a case that 2-step random access is configured on the target BWP, selecting or performing the 2-step random access, or confirming that the 2-step random access is available;
in a case that 4-step random access is configured on the target BWP, selecting or performing the 4-step random access, or confirming that the 4-step random access is available;
in a case that the 2-step random access and the 4-step random access are configured on the target BWP, selecting or performing the 2-step random access, or confirming that the 2-step random access is available; or in the case that the 2-step random access and the 4-step random access are configured on the target BWP, selecting or performing the 4-step random access, or confirming that the 4-step random access is available.

According to a seventh aspect, a terminal is provided. The terminal includes a processor and a memory. The memory stores a program or instructions runnable on the processor. The program or the instructions, when executed by the processor, implement steps of the switching method according to embodiments of this application, or the program or the instructions, when executed by the processor, implement steps of the random access processing method according to embodiments of this application.

According to an eighth aspect, a terminal is provided, including a processor and a communication interface. The processor is configured to or the communication interface is configured to perform a first operation in a case that a first bandwidth part BWP satisfies a first condition, where the first condition includes at least one of the following: a target configuration on the first BWP does not match a capability of the terminal, no 4-step random access is configured on the first BWP, or a random access failure occurs, where the target configuration includes at least one of the following: a random access channel RACH resource or a monitoring configuration for a downlink channel; and the first operation includes: switching to a second BWP; or initiating random access or monitoring the downlink channel on the second BWP; or on the first BWP, performing a 4-step random access procedure or monitoring a downlink channel corresponding to the 4-step random access procedure, where the first condition is that the target configuration on the first BWP does not match the capability of the terminal; or the processor is configured to or the communication interface is configured to perform a target operation on a target BWP, where the target operation includes at least one of the following: in a case that 2-step random access is configured on the target BWP, selecting or performing the 2-step random access, or confirming that the 2-step random access is available; in a case that 4-step random access is configured on the target BWP, selecting or performing the 4-step random access, or confirming that the 4-step random access is available; in a case that the 2-step random access and the 4-step random access are configured on the target BWP, selecting or performing the 2-step random access, or confirming that the 2-step random access is available; or in the case that the 2-step random access and the 4-step random access are configured on the target BWP, selecting or performing the 4-step random access, or confirming that the 4-step random access is available.

According to a ninth aspect, a network side device is provided. The network side device includes a processor and a memory. The memory stores a program or instructions runnable on the processor. The program or the instructions, when executed by the processor, implement steps of the configuration method according to embodiments of this application.

According to a tenth aspect, a network side device is provided, including a processor and a communication interface. The communication interface is configured to send configuration information to a terminal, where the configuration information is used for, in a case that the network side configures 2-step random access on a first bandwidth part BWP, configuring 4-step random access for the first BWP; or configuration content that the configuration information is used for satisfies at least one of the following: a RACH resource corresponding to the 2-step random access configured on the first BWP matches a capability of the terminal; a monitoring configuration for a downlink channel that corresponds to the 2-step random access configured on the first BWP matches the capability of the terminal; a RACH resource corresponding to the 4-step random access configured on the first BWP matches the capability of the terminal; or a monitoring configuration for the downlink channel that corresponds to the 4-step random access configured on the first BWP matches the capability of the terminal.

According to an eleventh aspect, a readable storage medium is provided. The readable storage medium stores a program or instructions. The program or the instructions, when executed by a processor, implement steps of the switching method according to embodiments of this application, or implement steps of the configuration method according to embodiments of this application, or implement steps of the random access processing method according to embodiments of this application.

According to a twelfth aspect, a wireless communication system is provided, including a terminal and a network side device. The terminal may be configured to perform steps of the switching method or the random access processing method according to embodiments of this application, and the network side device may be configured to perform steps of the configuration method according to embodiments of this application.

According to a thirteenth aspect, a chip is provided. The chip includes a processor and a communication interface. The communication interface is coupled to the processor. The processor is configured to run a program or instructions to implement the switching method according to embodiments of this application, or implement the configuration method according to embodiments of this application, or implement the random access processing method according to embodiments of this application.

According to a fourteenth aspect, a computer program/program product is provided. The computer program/program product is stored in a storage medium. The computer program/program product is executed by at least one processor, to implement steps of the switching method according to embodiments of this application, or the computer program/program product is executed by at least one processor, to implement steps of the configuration method according to embodiments of this application, or computer program/program product is executed by at least one processor, to implement steps of the random access processing method according to embodiments of this application.

In embodiments of this application, in the case that the first BWP satisfies the first condition, the terminal is switched to the second BWP, so that the terminal communicates on the second BWP. In the case that the first BWP satisfies the first condition, the random access is initiated or the downlink channel is monitored on the second BWP, so that the terminal can initiate the RACH procedure or monitor the downlink channel on the second BWP. In addition, in the case that the target configuration on the first BWP does not match the capability of the terminal, the 4-step random access procedure is performed or the downlink channel corresponding to the 4-step random access procedure is monitored on the first BWP.

### BRIEF DESCRIPTION OF THE DRAWINGS

FIG. 1 is a block diagram of a wireless communication system to which an embodiment of this application may be applied;

FIG. 2 is a schematic diagram of random access according to an embodiment of this application;

FIG. 3 is a schematic diagram of random access according to an embodiment of this application;

FIG. 4 is a flowchart of a switching method according to an embodiment of this application;

FIG. 5 is a flowchart of a configuration method according to an embodiment of this application;

FIG. 6 is a flowchart of a random access processing method according to an embodiment of this application;

FIG. 7 is a diagram of a structure of a switching apparatus according to an embodiment of this application;

FIG. 8 is a diagram of a structure of a configuration apparatus according to an embodiment of this application;

FIG. 9 is a diagram of a structure of a random access processing apparatus according to an embodiment of this application;

FIG. 10 is a diagram of a structure of a communication device according to an embodiment of this application;

FIG. 11 is a diagram of a structure of a terminal according to an embodiment of this application; and

FIG. 12 is a diagram of a structure of a network side device according to an embodiment of this application.

### DETAILED DESCRIPTION

The technical solutions in embodiments of this application are clearly described below with reference to the accompanying drawings in embodiments of this application. Apparently, the described embodiments are merely some rather than all of embodiments of this application. All other embodiments obtained by a person of ordinary skill in the art based on embodiments of this application fall within the protection scope of this application.

In this application, the terms “first”, “second”, and the like are used to distinguish similar objects, but are not used to describe a specific sequence or order. It should be understood that the terms used in such a way are interchangeable in a proper case, so that embodiments of this application can be implemented in an order different from the order shown or described herein. In addition, the objects distinguished by “first” and “second” are usually of a same type, without limiting a quantity of objects. For example, there may be one or more first objects. In addition, “or” in this application represents at least one of connected objects. For example, “A or B” covers three solutions, to be specific, solution 1: including A and excluding B; solution 2: including B and excluding A; and solution 3: including both A and B. The character “/” in this specification generally indicates an “or” relationship between the associated objects.

The term “indication” in this application may be a direct indication (or an explicit indication) or an indirect indication (or an implicit indication). The direct indication may be understood as that a sending party explicitly informs a receiving party of content such as specific information, an operation to be performed, or a request result in a sent indication. The indirect indication may be understood as that the receiving party determines corresponding information based on the indication sent by the sending party, or performing judgment and determines an operation to be performed, a request result, or the like based on a judgment result.

It should be noted that the technology described in embodiments of this application is not limited to a long term evolution (Long Term Evolution, LTE)/LTE-advanced (LTE-Advanced, LTE-A) system, and may further be used in other wireless communication systems, such as code division multiple access (Code Division Multiple Access, CDMA), time division multiple access (Time Division Multiple Access, TDMA), frequency division multiple access (Frequency Division Multiple Access, FDMA), orthogonal frequency division multiple access (Orthogonal Frequency Division Multiple Access, OFDMA), single-carrier frequency division multiple access (Single-carrier Frequency Division Multiple Access, SC-FDMA), or another system. The terms “system” and “network” in embodiments of this application are often used interchangeably, and the described technologies may be used to both the systems and radio technologies mentioned above as well as to other systems and radio technologies. The following descriptions describe a new radio (New Radio, NR) system for illustrative purposes, and NR terms are used in most of the descriptions below. However, these technologies may also be applied to a system other than the NR system, such as a 6th generation (6th Generation, 6G) communication system.

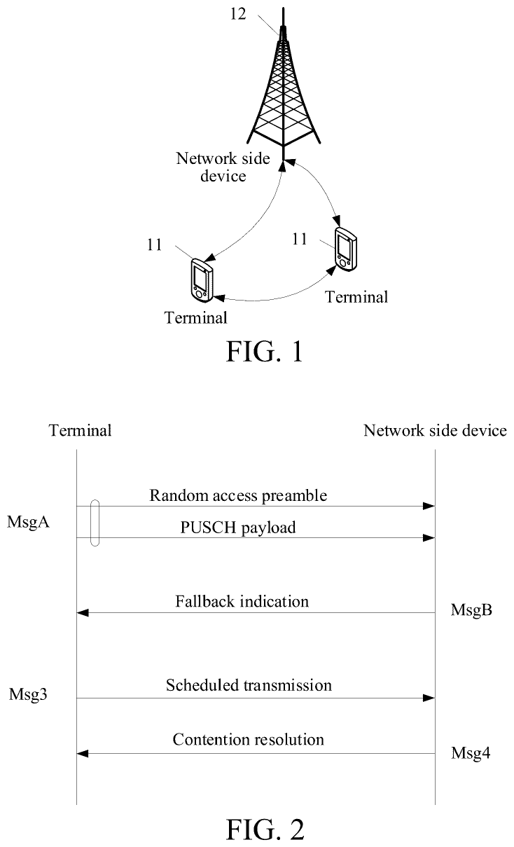

FIG. 1 is a block diagram of a wireless communication system to which an embodiment of this application may be applied. The wireless communication system includes a terminal 11 and a network side device 12. The terminal 11 may be a terminal side device such as a mobile phone, a tablet computer (Tablet Personal Computer), a laptop computer (Laptop Computer), a notebook computer, a personal digital assistant (Personal Digital Assistant, PDA), a palmtop computer, a netbook, an ultra-mobile personal computer (Ultra-mobile Personal Computer, UMPC), a mobile internet device (Mobile Internet Device, MID), an augmented reality (Augmented Reality, AR) device, a virtual reality (Virtual Reality, VR) device, a robot, a wearable device (Wearable Device), a flight vehicle (flight vehicle), a vehicle user equipment (Vehicle User Equipment, VUE), a ship-borne equipment, a pedestrian user equipment (Pedestrian User Equipment, PUE), a smart home appliance (a home device with a wireless communication capability, such as a refrigerator, a television, a washing machine, or furniture), a game console, a personal computer (Personal Computer, PC), a teller machine, or a self-service machine. The wearable device includes a smart watch, a smart bracelet, a smart headset, smart glasses, smart jewelry (a smart bracelet, a smart chain bracelet, a smart ring, a smart necklace, a smart ankle bangle, a smart ankle chain, and the like), a smart wristband, smart clothing, and the like. The vehicle user equipment may also be referred to as a vehicle terminal, a vehicle controller, a vehicle module, a vehicle component, a vehicle chip, a vehicle unit, or the like. It should be noted that a specific type of the terminal 11 is not limited in embodiments of this application. The network side device 12 may include an access network device or a core network device. The access network device may also be referred to as a radio access network (Radio Access Network, RAN) device, a radio access network function, or a radio access network unit. The access network device may include a base station, a wireless local area network (Wireless Local Area Network, WLAN) access point (Access Point, AP), a wireless fidelity (Wireless Fidelity, Wi-Fi) node, or the like. The base station may be referred to as a NodeB (NodeB, NB), an evolved NodeB (Evolved NodeB, eNB), the next generation NodeB (the next generation NodeB, gNB), a new radio NodeB (New Radio NodeB, NR NodeB), an access point, a relay base station (Relay Base Station, RBS), a serving base station (Serving Base Station, SBS), a base transceiver station (Base Transceiver Station, BTS), a radio base station, a radio transceiver, a basic service set (Basic Service Set, BSS), an extended service set (Extended Service Set, ESS), a home NodeB (home NodeB, HNB), a home evolved NodeB (home evolved NodeB), a transmission reception point (Transmission Reception Point, TRP) or some other suitable terms in the field provided that the same technical effect is achieved, and the base station is not limited to a specific technical term. It should be noted that in embodiments of this application, introduction is made only taking a base station in an NR system as an example, and a specific type of the base station is not limited.

The core network device may include, but is not limited to, a core network node, a core network function, a mobility management entity (Mobility Management Entity, MME), an access and mobility management function (Access and Mobility Management Function, AMF), a session management function (Session Management Function, SMF), a user plane function (User Plane Function, UPF), a policy control function (Policy Control Function, PCF), a policy and charging rules function (Policy and Charging Rules Function, PCRF), an edge application server discovery function (Edge Application Server Discovery Function, EASDF), unified data management (Unified Data Management, UDM), a unified data repository (Unified Data Repository, UDR), a home subscriber server (Home Subscriber Server, HSS), a centralized network configuration (Centralized network configuration, CNC), a network repository function (Network Repository Function, NRF), a network exposure function (Network Exposure Function, NEF), a local NEF (Local NEF, or L-NEF), a binding support function (Binding Support Function, BSF), an application function (Application Function, AF), and the like. It should be noted that in embodiments of this application, introduction is made only taking a core network device in the NR system as an example, and a specific type of the core network device is not limited.

In some implementations, a contention based random access procedure and a contention free random access procedure are included.

In a contention based 4-step random access procedure (which may also be referred to as a 4-step RACH for short), a terminal first sends a message 1 (Msg1) to a network, the message including a preamble (preamble). After detecting the preamble, the network sends a message 2 (Msg2) or a random access response (Random Access Response, RAR) message, Msg2 or the RAR message including numbers of preambles detected by the network, and allocates an uplink radio resource to the terminal for sending a message 3 (Msg3). After receiving Msg2 or the RAR message, the terminal confirms that at least one of the numbers of the preambles carried in Msg2 or the RAR message is the same as a number of the preamble sent by the terminal, and sends Msg3 including contention resolution information based on a resource indicated by Msg2 or the RAR message. After receiving Msg3, the network sends a message 4 (Msg4) including contention resolution information. The terminal receives Msg4, and confirms that the contention resolution information is the same as that sent by the terminal in Msg3. In this case, the 4-step random access is completed.

The network includes, in the RAR, uplink grant (UL grant) information, for indicating Msg3 physical uplink shared channel (Physical Uplink Shared Channel, PUSCH) scheduling information, and includes information such as a RACH preamble identifier (RACH preamble ID, RAPID), a temporary cell-radio network temporary identifier (temporary cell-radio network temporary identifier, TC-RNTI), and a timing advance (Timing Advance, TA). If the network does not receive the Msg3 PUSCH, the network may schedule retransmission of the Msg3 PUSCH in a TC-RNTI scrambled physical downlink control channel (Physical downlink control channel, PDCCH).

In some implementations, for the contention based random access, different terminals randomly select preambles for transmission. Therefore, different terminals may select a same preamble on a same time-frequency radio resource (random access occasion resource) for transmission. Such situation may be understood as a preamble collision between terminals. In this case, different terminals receive a same RAR, and different terminals perform transmission of the Msg3 PUSCH based on scheduling information in the RAR UL grant.

In some implementations, the network can only decode a PUSCH (including contention resolution information) transmitted by one terminal on one Msg3 PUSCH scheduling resource. Therefore, the network includes in Msg4 the received contention resolution information in Msg3. If the contention resolution information in Msg4 received by the terminal matches the contention resolution information sent by the terminal via the Msg3 PUSCH, the terminal considers that contention is resolved successfully. If the contention resolution information in Msg4 received by the terminal does not match the contention resolution information sent by the terminal via the Msg3 PUSCH, the terminal considers that resolution of the contention fails.

In some implementations, if the resolution of the contention fails, the terminal reselects a RACH transmission resource, performs physical random access channel (Physical Random Access Channel, PRACH) transmission, and attempts next random access.

In some implementations, a 2-step random access procedure (which may also be referred to as a 2-step RACH for short) is supported. First, a terminal sends a message A (MsgA) to a network side. Upon receiving of MsgA, the network side sends MsgB to the terminal. If the terminal does not receive a message B (MsgB) within a specific period of time, the terminal sends MsgA again together with an accumulated value of a counter counting a quantity of MsgA transmissions. If the counter counting the quantity of MsgA transmissions reaches a specific threshold, the terminal may switch from the 2-step random access procedure to the 4-step random access procedure. MsgA includes a MsgA preamble part and a MsgA PUSCH part. The preamble part is transmitted on a random access occasion (RACH Occasion, RO) used for the 2-step RACH. The PUSCH part is transmitted on MsgA PUSCH resources associated with sending the MsgA preamble and the RO. The MsgA PUSCH resources are a set of PUSCH resources, configured with respect to each PRACH slot, including time-frequency resources and DMRS resources.

In some implementations, a main procedure of the 2-step RA may be shown in FIG. 2 and is as follows:

A terminal sends MsgA (a MsgA PRACH and a MsgA PUSCH) to a network side.

After receiving MsgA, the network side sends a MsgB message to the UE.

If the MsgB received by the terminal includes a fallback RAR (FallbackRAR) matching the sent MsgA PRACH, the terminal retrieves data from an MsgA buffer (buffer) and stores the data in an Msg3 buffer. Subsequently, the UE sends Msg3 to the network side, and then performs contention resolution.

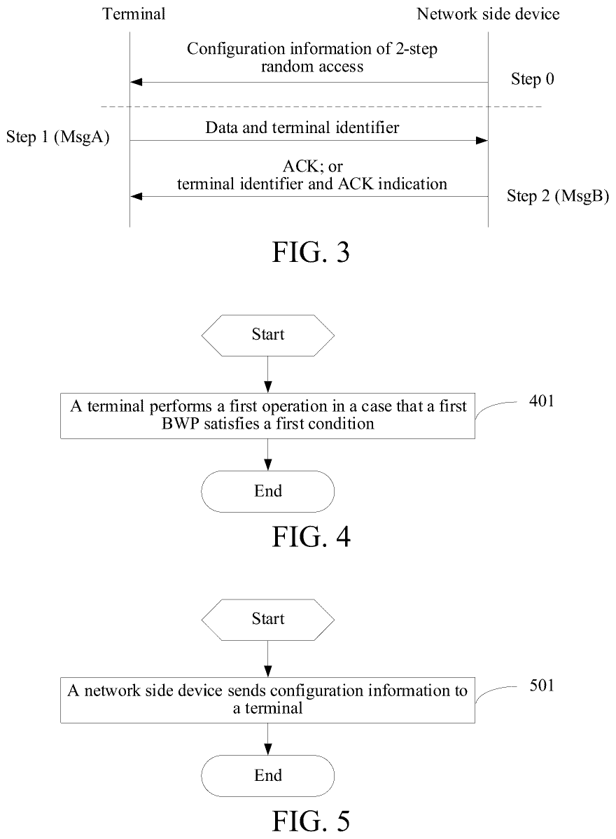

In some implementations, a main procedure of the 2-step RA may be shown in FIG. 3 and is as follows:

Step 0: A network side configures configuration information of the 2-step random access for a terminal, including, for example, transmission resource information corresponding to MsgA and MsgB.

Step 1: The terminal triggers a 2-step RACH procedure, and sends request information (MsgA) to the network side via, for example, a PUSCH. In addition, the UE may also send PRACH information to the network side.

Step 2: After sending MsgA, the terminal monitors receiving of MsgB in a period of time (that is, an RAR window). If the UE fails to receive MsgB, the UE resends MsgA.

For a terminal in a connected state, when a 2-step RACH is triggered due to uplink data arrival and uplink out-of-synchronization, the network side transmits MsgB after successfully receiving MsgA. For transmission of MsgB, the network side schedules transmission of a physical downlink shared channel (Physical Downlink Shared Channel, PDSCH) via a cell radio network temporary identifier (Cell Radio Network Temporary Identifier, C-RNTI) scrambled Physical Downlink Control Channel (Physical Downlink Control Channel, PDCCH). The PDSCH includes a media access control control element (Media Access Control Control Element, MAC CE) of the UE for uplink synchronization of the terminal.

In some implementations, a feature of small data transmission may be that, for user equipment (User Equipment, UE, that is, the terminal) in an unconnected state, excessive signaling overheads caused by radio resource control (Radio Resource Control, RRC) state conversion and RRC connection establishment processes are avoided, and the small data transmission is achieved through an extremely simple signaling process.

In some implementations, during the small data transmission, all current data radio bearers (Data Radio Bearers, DRBs) of the terminal are in a suspended state rather than in a released state. Before sending a resume request (Resume Request) message, the terminal may first resume the DRBs, and then uses RRC signaling to piggyback small data. In this case, same as a connected terminal (CONNECTED UE), the terminal may transmit data on the DRBs. Therefore, state conversion is avoided, and high-efficiency small data transmission is achieved with low signaling overheads.

In some implementations, because DRB transmission is used for small data transmission, and access stratum (Access Stratum, AS) security is activated, the small data transmission may provide necessary security protection on data, for example, operations such as data encryption and integrity protection. From the perspective of security, because the terminal may already move to another base station in the suspended state, a security key used by the terminal for data packet retransmission needs to be updated. An updating method is to perform a next key update operation based on a parameter provided, by the network side to the terminal when the terminal enters the suspended state, for calculating a next hop key.

In some implementations, to-be-transmitted data during the small data transmission (small data transmission, SDT) may be carried on a dedicated traffic channel (Dedicated Traffic Channel, DTCH), and transmitted after being multiplexed with an uplink RRC connection resume request (RRC Connection Resume Request) message. Similarly, if there is a returned downlink message, the data may also be carried on the DTCH and transmitted after being multiplexed with a downlink RRC connection release (RRC Connection Release) message. Both uplink data and downlink data are encrypted, and an updated next key is used for an encryption operation.

In some implementations, the small data transmission may be performed on a message 3 (Msg3) physical uplink shared channel (Physical Uplink Shared Channel, PUSCH) in a 4-step RACH procedure. Alternatively, the small data transmission may be performed on a message A (MsgA) PUSCH in a 2-step RACH procedure, or may be performed on a PUSCH resource scheduled by a configured grant configured in an RRC inactive (RRC inactive) state. The small data transmission in the 2-step RACH procedure and the 4-step RACH procedure is referred to as RACH based (RACH based) small data transmission, and may also be referred to as RA-SDT. The small data transmission based on the PUSCH scheduled by the configuration grant is referred to as CG based (configured grant based) small data transmission, and may also be referred to as CG-SDT.

In some implementations, subsequent transmission (subsequent transmission) of the RA-SDT may be cell radio network temporary identifier (Cell Radio Network Temporary Identifier, C-RNTI) scheduled transmission after contention resolution (Contention Resolution, CR).

In some implementations, after a downlink acknowledgement (Downlink Acknowledgement, DL ACK) for the configured grant (CG) sent in a common control channel (Common Control Channel, CCCCH) message is received, subsequent transmission is subsequent transmission belonging to the CG-SDT. In this case, the subsequent transmission may be based on the CG, or may be based on a dynamic grant (DG), or may be based on a dynamic downlink assignment (dynamic DL assignment).

In some implementations, the terminal may perform one or more of the following operations on an initial downlink BWP (initial DL BWP) of a cell: receiving a synchronization signal block, uplink sending (in a corresponding initial uplink BWP) in a random access procedure, downlink receiving, and receiving system information and paging information, and radio resource management (Radio resource management, RRM) measurement and cell reselection determining based on a cell defining synchronization signal block (cell defining SSB, CD-SSB) in the initial downlink BWP.

In some implementations, support is provided for configuring an additional initial DL BWP for some terminals (for example, some types of terminals such as reduced capability terminals (redcap UEs)). The terminal can perform the foregoing sending and receiving operations on the additional BWP. The additional BWP and the initial downlink BWP may be completely non-overlap, partially overlap, or have an inclusive relationship in frequency domain. Because the terminal needs to perform operations such as downlink synchronization, measurement, and automatic gain control (Automatic Gain Control, AGC) based on the SSB, if the additional initial DL BWP does not include an SSB, the terminal may need to frequently perform radio frequency retuning (RF retuning), that is, repeatedly return from the additional initial DL BWP to a bandwidth of a first downlink BWP to receive the SSB. This can lead to increased terminal power consumption, a higher probability of service interruption, and degraded system performance. Therefore, including one SSB in the additional initial DL BWP can reduce power consumption of sending and receiving on the BWP by the terminal. A second SSB can typically be a non-cell defining SSB (Non-cell defining SSB, NCD-SSB), that is, the SSB does not include an indication for system information reception configuration.

In some implementations, the terminal may determine a position and a frequency of the second SSB on the additional initial DL BWP based on system information in the initial downlink BWP or higher layer signaling, and configure a frequency of the terminal on the second SSB to perform RRM measurement. The measurement may be intra-frequency (intra-frequency) measurement and may include measurement of a serving cell and measurement of a neighboring cell on a same frequency. The terminal determines, based on a measurement result, whether to initiate neighboring cell measurement or to perform neighboring cell reselection on the frequency.

In some implementations, before performing intra-frequency measurement and inter-frequency measurement, the terminal first performs measurement of the serving cell. When a result of measurement of the serving cell exceeds a threshold, the terminal may skip the intra-frequency measurement or the inter-frequency measurement. The measurement result may include reference signal received power (Reference Signal Received Power, RSRP) or reference signal received quality (Reference Signal Received Quality, RSRQ).

It should be noted that some of the implementations described above are merely examples used to illustrate the method provided in embodiments of this application, and should not be construed as limitation on the method provided in embodiments of this application.

The following describes in detail a switching method, a configuration method, a random access processing method, and a device according to embodiments of this application through some embodiments and application scenarios thereof with reference to the accompanying drawings.

FIG. 4 is a flowchart of a switching method according to an embodiment of this application. As shown in FIG. 4, the method includes the following steps.

Step 401: A terminal performs a first operation in a case that a first BWP satisfies a first condition, where the first condition includes at least one of the following: a target configuration on the first BWP does not match a capability of the terminal, no 4-step random access is configured on the first BWP, or a random access failure occurs, where the target configuration includes at least one of the following: a random access channel RACH resource or a monitoring configuration for a downlink channel; and the first operation includes:
switching to a second BWP; or
initiating random access or monitoring the downlink channel on the second BWP; or
on the first BWP, performing a 4-step random access procedure or monitoring a downlink channel corresponding to the 4-step random access procedure, where the first condition is that the target configuration on the first BWP does not match the capability of the terminal.

That a target configuration on the first BWP does not match a capability of the terminal may be that the terminal is unable to or cannot perform random access based on the target configuration, or is unable to or cannot perform downlink channel monitoring based on the configuration.

The RACH resource may include at least one of the following:
a RACH resource corresponding to 2-step random access; or
a RACH resource corresponding to the 4-step random access.

The RACH resource corresponding to the foregoing 2-step random access include at least one of the following:
a resource of MsgA (that is, a MsgA PUSCH resource) or a resource of MsgB (that is, a MsgB PDSCH resource).

The RACH resource corresponding to the foregoing 4-step random access include at least one of the following:
a resource of Msg1, a resource of Msg2, a resource of Msg3, or a resource of Msg4.

The foregoing monitoring configuration for the downlink channel may include a monitoring resource for the downlink channel.

The foregoing RACH resource includes a bandwidth resource, a time resource, a frequency resource, or a code resource for transmission of Msg1 or Msg3 or MsgA, and a bandwidth resource, a time resource, a frequency resource, or a code resource for scheduling Msg2 or Msg4 or MsgB.

The 4-step random access may be contention based random access (contention based random access).

The 2-step random access may be contention free random access (contention free random access) or a 2-step RACH including MsgA/MsgB.

That a random access failure occurs may be that the random access failure occurs on the first BWP.

The switching to a second BWP may be that the terminal switches to the second BWP for communication, for example, switches to the second BWP to perform a random access procedure, switches to the second BWP to perform an operation related to the random access procedure, and switches to the second BWP to perform RA-SDT, CG-SDT, or another operation.

The switching to a second BWP includes switching from the first BWP to the second BWP.

In addition, after the second BWP is switched to, the 2-step random access or the 4-step random access may be initiated.

The initiating random access or monitoring a downlink channel on the second BWP includes:
initiating the random access on the second BWP, and monitoring the downlink channel on another BWP, for example, monitoring the downlink channel on the first BWP; or
monitoring the downlink channel on the second BWP, and initiating the random access on another BWP, for example, initiating a RACH procedure on the first BWP; or
initiating the random access on the second BWP, and monitoring the downlink channel on the second BWP.

In addition, in a case that the random access is initiated or the downlink channel is monitored on the second BWP, a BWP corresponding to another operation remains unchanged. For example, RA-SDT, CG-SDT, or another operation is performed on the first BWP.

In addition, initiating the random access on the second BWP may also be initiating a RACH procedure on the second BWP, for example, initiating a 2-step random access procedure or a 4-step random access procedure. The monitoring a downlink channel on the second BWP may be monitoring a downlink channel corresponding to the 2-step random access procedure on the second BWP, or monitoring a downlink channel corresponding to the 4-step random access procedure on the second BWP.

The on the first BWP, performing a 4-step random access procedure or monitoring a downlink channel corresponding to the 4-step random access procedure refers to, in a case that the target configuration on the first BWP does not match the capability of the terminal, on the first BWP, performing the 4-step random access procedure or monitoring the downlink channel corresponding to the 4-step random access procedure. For example, in a case that a RACH resource of the 2-step random access on the first BWP does not match the capability of the terminal, the 4-step random access procedure is performed or the downlink channel corresponding to the 4-step random access procedure is monitored on the first BWP; or in a case that a monitoring configuration for the downlink channel corresponding to the 2-step random access on the first BWP does not match the capability of the terminal, the 4-step random access procedure is performed or the downlink channel corresponding to the 4-step random access procedure is monitored on the first BWP.

The switching to a second BWP or the initiating random access or monitoring a downlink channel on the second BWP is performed in a case that the target configuration on the first BWP does not match the capability of the terminal or no 4-step random access is configured on the first BWP. For example, in the case that the target configuration on the first BWP does not match the capability of the terminal or no 4-step random access is configured on the first BWP, the second BWP is switched to; or in the case that the target configuration on the first BWP does not match the capability of the terminal or no 4-step random access is configured on the first BWP, the random access is initiated or the downlink channel is monitored on the second BWP.

In some implementations, the switching to a second BWP may be switching to a second uplink BWP or a second downlink BWP.

In some implementations, the switching to a second BWP may be switching from the first BWP to the second BWP.

In some implementations, the initiating a RACH procedure on the second BWP is initiating the RACH procedure on the second uplink BWP, and the monitoring a downlink channel on the second BWP is monitoring the downlink channel on the second downlink BWP.

In some implementations, the performing a 4-step random access procedure on the first BWP is performing the 4-step random access procedure on a first uplink BWP, and the monitoring, on the first BWP, a downlink channel corresponding to the 4-step random access procedure is monitoring, on a first downlink BWP, the downlink channel corresponding to the 4-step random access procedure.

In this embodiment of this application, in the case that the first BWP satisfies the first condition, the terminal is switched to the second BWP, so that the terminal communicates on the second BWP, so as to improve communication performance of the terminal. In the case that the first BWP satisfies the first condition, the random access is initiated or the downlink channel is monitored on the second BWP, so that the terminal can initiate the RACH procedure or monitor the downlink channel on the second BWP, so as to improve the communication performance of the terminal. In addition, in the case that the target configuration on the first BWP does not match the capability of the terminal, the 4-step random access procedure is performed or the downlink channel corresponding to the 4-step random access procedure is monitored on the first BWP, to improve a success rate of the random access of the terminal, so as to improve the communication performance of the terminal.

In this embodiment of this application, the 4-step random access may be the contention based random access, that is, contention based 4-step random access.

In an optional implementation, that a target configuration does not match a capability of the terminal includes:
the target configuration exceeds the capability of the terminal; or
the target configuration exceeds capabilities of some terminals of a terminal type, where the terminal type is a terminal type to which the terminal belongs.

In some implementations, the capability of the terminal may include at least one of the following:
a radio frequency RF bandwidth, a baseband bandwidth, an operating bandwidth, or a quantity of antennas.

That the target configuration exceeds the capability of the terminal may be that a bandwidth corresponding to the target configuration exceeds the capability of the terminal, for example, a bandwidth of the RACH resource exceeds the capability of the terminal, or a bandwidth corresponding to the monitoring configuration for the downlink channel exceeds the capability of the terminal.

In addition, that the target configuration exceeds capabilities of some terminals of a terminal type may refer to that the terminal type includes terminals having different capabilities, and the target configuration exceeds the capabilities of some terminals. For example, there may be two implementations for a terminal type of enhanced reduced capability UE (enhanced reduced capability UE, eRedCap UE). One is 20 MHz+peak data rate reduction (Peak data rate reduction, PR) 1, and the other one is bandwidth (Bandwidth, BW) 3/PR3+PR1. Both implementations can reach approximately 10 Mbps required by the eRedCap UE. In this way, if the target configuration is greater than 5 MHz, the target configuration exceeds the capability corresponding to the terminal in the implementation of BW3/PR3+PR1, but does not exceed the capability corresponding to the terminal in the implementation of 20 MHz+PR1.

In this implementation, in a case that the target configuration exceeds the capability of the terminal or the target configuration exceeds the capabilities of some terminals of the terminal type, the terminal can perform a related operation on the second BWP, or perform an operation related to the 4-step random access on the first BWP, to improve communication performance of the terminal.

In an optional implementation, that a terminal performs a first operation includes:
the terminal performs the first operation in a case that a second condition is satisfied, where the second condition includes at least one of the following:
the 2-step random access is configured on the second BWP;
a RACH resource corresponding to the 2-step random access configured on the second BWP matches the capability of the terminal;
the 4-step random access is configured on the second BWP;
a RACH resource corresponding to the 4-step random access configured on the second BWP matches the capability of the terminal; or
a monitoring configuration for the downlink channel that is configured on the second BWP matches the capability of the terminal; and
the first operation includes:
switching to the second BWP; or
initiating the random access or monitoring the downlink channel on the second BWP.

In this embodiment, that the terminal performs the first operation in a case that a second condition is satisfied may also be understood as that the second BWP satisfies the second condition. The second condition includes:
the 2-step random access is configured on the second BWP;
the RACH resource corresponding to the 2-step random access configured on the second BWP matches the capability of the terminal;
the 4-step random access is configured on the second BWP;
the RACH resource corresponding to the 4-step random access configured on the second BWP matches the capability of the terminal; and
the monitoring configuration for the downlink channel that is configured on the second BWP matches the capability of the terminal.

That the 2-step random access is configured on the second BWP may include at least one of the following:
a 2-step random access type is configured on the second BWP;
the RACH resource corresponding to the 2-step random access is configured on the second BWP; or
a monitoring configuration for the downlink channel that corresponds to the 2-step random access is configured on the second BWP.

That the 4-step random access is configured on the second BWP may include at least one of the following:
a 4-step random access type is configured on the second BWP;
the RACH resource corresponding to the 4-step random access is configured on the second BWP; or
a monitoring configuration for the downlink channel that corresponds to the 4-step random access is configured on the second BWP.

In some implementations, configurations on a BWP may be configured by a network side for the BWP, and may be notified to the terminal by using a configuration message. These configurations may be effective configurations for a plurality of terminals.

That the RACH resource corresponding to the 2-step random access configured on the second BWP matches the capability of the terminal may include at least one of the following:
the RACH resource corresponding to the 2-step random access configured on the second BWP does not exceed the capability of the terminal; or
the RACH resource corresponding to the 2-step random access configured on the second BWP do not exceed the capabilities of some terminals of the terminal type.

That the RACH resource corresponding to the 4-step random access configured on the second BWP matches the capability of the terminal may include at least one of the following:
the RACH resource corresponding to the 4-step random access configured on the second BWP does not exceed the capability of the terminal; or
the RACH resource corresponding to the 4-step random access configured on the second BWP do not exceed the capabilities of some terminals of the terminal type.

That the monitoring configuration for the downlink channel that is configured on the second BWP matches the capability of the terminal may include at least one of the following:
the monitoring configuration for the downlink channel that is configured on the second BWP does not exceed the capability of the terminal; or
the monitoring configuration for the downlink channel that is configured on the second BWP does not exceed the capabilities of some terminals of the terminal type.

In the foregoing implementation, because the foregoing second condition is satisfied, the terminal switches to the second BWP, or initiates the random access or monitors the downlink channel on the second BWP, so that communication reliability of the terminal can be improved. For example, a success rate of the random access is improved, for example, reliability of monitoring of the downlink channel is improved.

In some implementations, the second BWP may be an additional initial BWP (Separate initial BWP) or a conventional initial BWP (legacy initial BWP).

In an optional implementation, the method further includes:

The terminal performs a second operation in a case that the first BWP satisfies the first condition and the second BWP does not satisfy the second condition, where the second operation includes:
switching to a third BWP; or
initiating a RACH procedure or monitoring the downlink channel on the third BWP.

In this implementation, in a case that the first BWP satisfies the first condition and the second BWP does not satisfy the second condition, the third BWP can be switched to, or the RACH procedure can be initiated or the downlink channel can be monitored on the third BWP. In this way, the terminal can communicate on the third BWP by switching to the third BWP, to improve communication performance of the terminal. In addition, the terminal can initiate the RACH procedure or monitor the downlink channel on the third BWP, to improve the communication performance of the terminal.

Optionally, the second BWP includes an additional initial BWP (Separate initial BWP); or
the third BWP includes an initial BWP.

The additional initial BWP may be understood as another initial BWP other than an initial BWP defined by a protocol, for example, a reduced capability (reduced capability, RedCap) specific initial BWP (specific initial BWP).

For example, a network configures the separate initial BWP for the terminal. For example, the foregoing second BWP is the separate initial BWP, and when the separate initial BWP does not satisfy the foregoing second condition, the third BWP is switched to.

The foregoing initial BWP may also be referred to as a conventional initial BWP (legacy initial BWP).

In this implementation, in a case that the additional initial BWP does not satisfy the foregoing second condition, the initial BWP can be switched to, or the RACH procedure can be initiated or the downlink channel can be monitored on the initial BWP, to improve communication performance of the terminal.

Optionally, the third BWP satisfies a third condition, and the third condition includes:
the 2-step random access is configured on the third BWP;
a RACH resource corresponding to the 2-step random access configured on the third BWP matches the capability of the terminal;
the 4-step random access is configured on the third BWP;
a RACH resource corresponding to the 4-step random access configured on the third BWP matches the capability of the terminal; and
a monitoring configuration for the downlink channel that is configured on the third BWP matches the capability of the terminal.

That a RACH resource corresponding to the 2-step random access configured on the third BWP matches the capability of the terminal may include at least one of the following:
the RACH resource corresponding to the 2-step random access configured on the third BWP does not exceed the capability of the terminal; or
the RACH resource corresponding to the 2-step random access configured on the third BWP do not exceed the capabilities of some terminals of the terminal type.

That a RACH resource corresponding to the 4-step random access configured on the third BWP matches the capability of the terminal may include at least one of the following:
the RACH resource corresponding to the 4-step random access configured on the third BWP does not exceed the capability of the terminal; or
the RACH resource corresponding to the 4-step random access configured on the third BWP do not exceed the capabilities of some terminals of the terminal type.

That a monitoring configuration for the downlink channel that is configured on the third BWP matches the capability of the terminal may include at least one of the following:
the monitoring configuration for the downlink channel that is configured on the third BWP does not exceed the capability of the terminal; or
the monitoring configuration for the downlink channel that is configured on the third BWP does not exceed the capabilities of some terminals of the terminal type.

In the foregoing implementation, because the third BWP satisfies the foregoing third condition, the terminal switches to the third BWP, or initiates the RACH procedure or monitors the downlink channel on the third BWP, so that communication reliability of the terminal can be improved. For example, a success rate of the random access is improved, for example, reliability of monitoring of the downlink channel is improved.

Optionally, the first BWP includes at least one of the following: a first uplink BWP or a first downlink BWP; or
the third BWP includes at least one of the following: a third uplink BWP or a third downlink BWP; or
the switching to a third BWP includes at least one of the following:
switching to the third uplink BWP; or
switching to the third downlink BWP.

In this implementation, switching to an uplink BWP or a downlink BWP can be implemented. In this way, requirements of the terminal can be more flexibly adapted to, to further improve communication performance of the terminal.

In an optional implementation, the first BWP includes at least one of the following: a first uplink BWP or a first downlink BWP; or
the second BWP includes at least one of the following: a second uplink BWP or a second downlink BWP; or
the switching to a second BWP includes at least one of the following:
switching to the second uplink BWP; or
switching to the second downlink BWP.

In this implementation, switching to an uplink BWP or a downlink BWP can be implemented. In this way, requirements of the terminal can be more flexibly adapted to, to further improve communication performance of the terminal.

In an optional implementation, the first operation is performed in a case that a RACH failure or a downlink monitoring failure occurs on the first BWP.

For example, in a case that no 4-step random access is configured on the first BWP and a RACH failure or a downlink monitoring failure occurs on the first BWP, the second BWP is switched to, or the random access is initiated or the downlink channel is monitored on the second BWP.

In this way, a success rate of terminal access can be improved by performing the foregoing first operation.

In an optional implementation, the performing a 4-step random access procedure on the first BWP includes:
in a case that the RACH resource includes the RACH resource corresponding to the 2-step random access and the 4-step random access is configured on the first BWP, performing, by the terminal, the 4-step random access procedure on the first BWP; or
the monitoring, on the first BWP, a downlink channel corresponding to the 4-step random access procedure includes:

in a case that the monitoring configuration for the downlink channel is the monitoring configuration for the downlink channel that corresponds to the 2-step random access and a monitoring configuration for the downlink channel that corresponds to the 4-step random access is configured on the first BWP, monitoring, on the first BWP, the downlink channel corresponding to the 4-step random access.

That the 4-step random access is configured on the first BWP may include at least one of the following:
a 4-step random access type is configured on the first BWP;
a RACH resource corresponding to the 4-step random access is configured on the first BWP; or
a monitoring configuration for the downlink channel that corresponds to the 4-step random access is configured on the first BWP.

The 4-step random access configured on the first BWP or the monitoring configuration for the downlink channel that corresponds to the 4-step random access configured on the first BWP may be configured by a network side device by using a configuration message. In addition, in some implementations, the network side device may ensure, by using the configuration message, that the RACH resource of the 4-step random access configured on the first BWP matches the capability of the terminal, and ensure that the monitoring configuration for the downlink channel that corresponds to the 4-step random access configured on the first BWP matches the capability of the terminal.

In this implementation, because in a case that the 4-step random access is configured on the first BWP, the terminal performs the 4-step random access procedure on the first BWP, a success rate of the random access of the terminal can be improved. In a case that the monitoring configuration for the downlink channel that corresponds to the 4-step random access is configured on the first BWP, the downlink channel corresponding to the 4-step random access is monitored on the first BWP, so that reliability of downlink channel monitoring of the terminal can be improved.

Optionally, the method further includes:

The terminal obtains configuration information, where the configuration information is used for configuring at least one of the following:
configuring the 2-step random access and the 4-step random access on the first BWP;
configuring, on the first BWP, the RACH resource corresponding to the 2-step random access and the RACH resource corresponding to the 4-step random access; or
configuring, on the first BWP, the monitoring configuration for the downlink channel that corresponds to the 2-step random access and the monitoring configuration for the downlink channel that corresponds to the 4-step random access.

The configuration information is configuration information received by the terminal from the network side device.

The configuring the 2-step random access and the 4-step random access on the first BWP may be that when the network side configures the 2-step random access on the first BWP, the network side also configures the 4-step random access on the first BWP. In this way, when the 2-step random access does not match the capability of the terminal, the 4-step random access may be initiated on the first BWP, to prevent the terminal from switching to another BWP, so as to reduce power consumption of the terminal.

In this implementation, because at least one of the foregoing items is configured in the configuration information, the terminal can directly initiate, on the first BWP based on the content configured in the configuration information, the 4-step random access or monitors the monitoring configuration for the downlink channel that corresponds to the 4-step random access, to improve a success rate of the random access of the terminal, and improve reliability of monitoring of the downlink channel of the terminal.

Optionally, the RACH resource corresponding to the 4-step random access configured on the first BWP matches the capability of the terminal; or the monitoring configuration for the downlink channel that corresponds to the 4-step random access configured on the first BWP matches the capability of the terminal.

That the RACH resource corresponding to the 4-step random access configured on the first BWP matches the capability of the terminal may include at least one of the following:
the RACH resource corresponding to the 4-step random access configured on the first BWP does not exceed the capability of the terminal; or
the RACH resource corresponding to the 4-step random access configured on the first BWP do not exceed the capabilities of some terminals of the terminal type.

That the monitoring configuration for the downlink channel that corresponds to the 4-step random access configured on the first BWP matches the capability of the terminal may include at least one of the following:
the monitoring configuration for the downlink channel that corresponds to the 4-step random access configured on the first BWP does not exceed the capability of the terminal; or
the monitoring configuration for the downlink channel that corresponds to the 4-step random access configured on the first BWP does not exceed the capabilities of some terminals of the terminal type.

In this implementation, because the RACH resource corresponding to the 4-step random access configured on the first BWP matches the capability of the terminal, or the monitoring configuration for the downlink channel that corresponds to the 4-step random access configured on the first BWP matches the capability of the terminal, communication reliability of the terminal can be improved, for example, a success rate of the random access is improved, for example, reliability of monitoring of the downlink channel is improved.

In an optional implementation, the first BWP includes at least one of the following:
an active BWP, a configured BWP, a deactivated BWP, an additional initial BWP, a BWP including a cell defining synchronization signal block CD-SSB, a BWP including a non-cell defining synchronization signal block NCD-SSB, a BWP including a control resource set (Control resource set, CORESET) #0, a first preset BWP, a default BWP, a fallback BWP, a BWP on which the RACH resource corresponding to the 4-step random access is configured, a BWP on which the RACH resource corresponding to the 2-step random access is configured, or a BWP on which a third operation is performed, where the third operation includes at least one of the following:
receiving a system information SI, monitoring paging, monitoring a paging early indication (Paging Early Indication, PEI), receiving an SSB, random access, measuring a CD-SSB, cell selection, cell reselection, camping, or SDT.

The active BWP may include a currently active BWP or a first active BWP (First active BWP).

The first preset BWP may be defined by a protocol or configured by the network side. For example, the protocol specifies or the network side configures a BWP used for a 4-step RACH or for fallback from a 2-step RACH to the 4-step RACH.

The default BWP (Default BWP) may be a default BWP used for the 4-step RACH or for fallback from the 2-step RACH to the 4-step RACH.

The fallback BWP (fallback BWP) may be a fallback BWP used for the 4-step RACH or for fallback from the 2-step RACH to the 4-step RACH.

The foregoing BWP on which the RACH resource corresponding to the 4-step random access is configured may be referred to as a BWP including the RACH resource corresponding to the 4-step random access.

The foregoing BWP on which the RACH resource corresponding to the 2-step random access is configured may be referred to as a BWP including the RACH resource corresponding to the 2-step random access, and the RACH resource corresponding to the 2-step random access configured on the BWP does not exceed the capability of the terminal.

The SDT may include at least one of the following:

RA-SDT, CG-SDT, subsequent transmission (subsequent transmission) of the RA-SDT, or subsequent transmission (subsequent transmission) of the CG-SDT.

In this implementation, because the first BWP includes at least one of the foregoing BWPs, BWP switching or random access may be applied to more scenarios, to satisfy requirements of different services or different scenarios of the terminal.

In an optional implementation, the second BWP includes at least one of the following:
an initial BWP, an additional initial BWP, a BWP including a CD-SSB, a BWP including an NCD-SSB, a BWP including a CORESET #0, a second preset BWP, a default BWP, a backoff BWP, a BWP on which the RACH resource corresponding to the 4-step random access is configured, a BWP on which the RACH resource corresponding to the 2-step random access is configured, or a BWP on which a fourth operation is performed, where the fourth operation includes at least one of the following:
receiving a system information SI, monitoring paging, monitoring a PEI, receiving an SSB, random access, measuring a CD-SSB, cell selection, cell reselection, camping, or SDT.

The active BWP may include a currently active BWP or a first active BWP (First active BWP).

The second preset BWP may be defined by a protocol or configured by the network side. For example, the protocol specifies or the network side configures a BWP used for a 4-step RACH or for fallback from a 2-step RACH to the 4-step RACH.

The default BWP (Default BWP) may be a default BWP used for the 4-step RACH or for fallback from the 2-step RACH to the 4-step RACH.

The fallback BWP (fallback BWP) may be a fallback BWP used for the 4-step RACH or for fallback from the 2-step RACH to the 4-step RACH.

The foregoing BWP on which the RACH resource corresponding to the 4-step random access is configured may be referred to as a BWP including the RACH resource corresponding to the 4-step random access.

The foregoing BWP on which the RACH resource corresponding to the 2-step random access is configured may be referred to as a BWP including the RACH resource corresponding to the 2-step random access, and the RACH resource corresponding to the 2-step random access configured on the BWP does not exceed the capability of the terminal.

The SDT may include at least one of the following:

RA-SDT, CG-SDT, subsequent transmission (subsequent transmission) of the RA-SDT, or subsequent transmission (subsequent transmission) of the CG-SDT.

In this implementation, because the second BWP includes at least one of the foregoing BWPs, BWP switching or random access may be applied to more scenarios, to satisfy requirements of different services or different scenarios of the terminal.

In an optional implementation, the third BWP includes at least one of the following:
an initial BWP, an additional initial BWP, a BWP including a CD-SSB, a BWP including an NCD-SSB, a BWP including a CORESET #0,a second preset BWP, a default BWP, a backoff BWP, a BWP on which the RACH resource corresponding to the 4-step random access is configured, a BWP on which the RACH resource corresponding to the 2-step random access is configured, or a BWP on which a second operation is performed, where the second operation includes at least one of the following:
receiving a system information SI, monitoring paging, monitoring a PEI, receiving an SSB, random access, measuring a CD-SSB, cell selection, cell reselection, camping, or SDT.

In this implementation, because the third BWP includes at least one of the foregoing BWPs, BWP switching or random access may be applied to more scenarios, to satisfy requirements of different services or different scenarios of the terminal.

In an optional implementation, in a case that the terminal switches to the second BWP or the terminal initiates the RACH procedure on the second BWP, the terminal performs at least one of the following for the second BWP:
in a case that the 2-step random access is configured on the second BWP, selecting or performing the 2-step random access, or confirming that the 2-step random access is available;
in a case that the 4-step random access is configured on the second BWP, selecting or performing the 4-step random access, or confirming that the 4-step random access is available;
in a case that the 2-step random access and the 4-step random access are configured on the second BWP, selecting or performing the 2-step random access, or confirming that the 2-step random access is available; or in the case that the 2-step random access and the 4-step random access are configured on the second BWP, selecting or performing the 4-step random access, or confirming that the 4-step random access is available.

The selecting the 2-step random access may include at least one of the following:
selecting the 2-step random access type;
selecting the RACH resource corresponding to the 2-step random access; or
select a RACH resource set corresponding to the 2-step random access.

The performing the 2-step random access may include at least one of the following:
performing the RACH procedure by using the RACH resource corresponding to the 2-step random access.

The confirming that the 2-step random access is available may include at least one of the following:
confirming that the 2-step random access type is available; or
confirming that the RACH resource corresponding to the 2-step random access is available.

The selecting the 4-step random access may include at least one of the following:
selecting the 4-step random access type;
selecting the RACH resource corresponding to the 4-step random access; or
select a RACH resource set corresponding to the 4-step random access.

The performing the 4-step random access may include at least one of the following:
performing the RACH procedure by using the RACH resource corresponding to the 4-step random access.

The confirming that the 4-step random access is available may include at least one of the following:
confirming that the 4-step random access type is available; or
confirming that the RACH resource corresponding to the 4-step random access is available.

In the foregoing implementation, corresponding random access can be flexibly selected or performed, and the corresponding random access can be flexibly determined to be available, to help improve a success rate of the random access of the terminal.

Optionally, the in a case that the 2-step random access is configured on the second BWP, selecting or performing the 2-step random access, or confirming that the 2-step random access is available includes:
in a case that the 2-step random access is configured on the second BWP and the RACH resource corresponding to the 2-step random access configured on the second BWP matches the capability of the terminal, selecting or performing the 2-step random access, or confirming that the 2-step random access is available.

In this implementation, in a case that the RACH resource corresponding to the 2-step random access configured on the second BWP matches the capability of the terminal, the 2-step random access can be selected or performed, or the 2-step random access can be confirmed to be available, so as to improve a success rate of the random access of the terminal.

In some implementations, if the 2-step random access is configured on the second BWP, the terminal selects or performs the 2-step random access on the second BWP, or the terminal considers that the 2-step random access is available. For example, the RACH resource or the monitoring configuration for the downlink channel that corresponds to the 2-step random access configured by the network side matches the capability of the terminal. For example, the network side ensures that the configured 2-step random access or a scheduled resource in a process of performing the 2-step random access matches the capability of the terminal.

Optionally, the in a case that the 4-step random access is configured on the second BWP, selecting or performing the 4-step random access, or confirming that the 4-step random access is available includes:
in a case that the 4-step random access is configured on the second BWP and the RACH resource corresponding to the 4-step random access configured on the second BWP matches the capability of the terminal, selecting or performing the 4-step random access, or confirming that the 4-step random access is available.

In this implementation, in a case that the RACH resource corresponding to the 4-step random access configured on the second BWP matches the capability of the terminal, the 4-step random access can be selected or performed, or the 4-step random access can be confirmed to be available, so as to improve a success rate of the random access of the terminal.

In some implementations, if the 4-step random access is configured on the second BWP, the terminal selects or performs the 4-step random access on the second BWP, or the terminal considers that the 4-step random access is available. For example, the RACH resource or the monitoring configuration for the downlink channel that corresponds to the 4-step random access configured by the network side matches the capability of the terminal. For example, the network side ensures that the configured 4-step random access or a scheduled resource in a process of performing the 4-step random access matches the capability of the terminal.

Optionally, the in a case that the 2-step random access and the 4-step random access are configured on the second BWP, selecting or performing the 2-step random access, or confirming that the 2-step random access is available includes:
in a case that the 2-step random access and the 4-step random access are configured on the second BWP and the RACH resource corresponding to the 2-step random access configured on the second BWP matches the capability of the terminal, selecting or performing the 2-step random access, or confirming that the 2-step random access is available; or
the in the case that the 2-step random access and the 4-step random access are configured on the second BWP, selecting or performing the 4-step random access, or confirming that the 4-step random access is available includes:
in a case that the 2-step random access and the 4-step random access are configured on the second BWP and the RACH resource corresponding to the 2-step random access configured on the second BWP does not match the capability of the terminal, selecting or performing the 4-step random access, or confirming that the 4-step random access is available.

That the RACH resource corresponding to the 2-step random access configured on the second BWP matches the capability of the terminal may include at least one of the following:
the RACH resource corresponding to the 2-step random access configured on the second BWP matches the capability of the terminal, and whether the RACH resource corresponding to the 4-step random access configured on the second BWP matches the capability of the terminal is not considered;
the RACH resource corresponding to the 2-step random access configured on the second BWP matches the capability of the terminal, and the RACH resource corresponding to the 4-step random access configured on the second BWP matches the capability of the terminal; or
the RACH resource corresponding to the 2-step random access configured on the second BWP matches the capability of the terminal, and the RACH resource corresponding to the 4-step random access configured on the second BWP does not match the capability of the terminal.

In this implementation, in a case that the RACH resource corresponding to the 2-step random access configured on the second BWP matches the capability of the terminal, the 2-step random access can be preferentially selected or performed, or the 2-step random access can be preferentially confirmed to be available, so as to improve efficiency of the random access of the terminal.

That the RACH resource corresponding to the 4-step random access configured on the second BWP matches the capability of the terminal may include at least one of the following:
the RACH resource corresponding to the 4-step random access configured on the second BWP matches the capability of the terminal, and whether the RACH resource corresponding to the 2-step random access configured on the second BWP matches the capability of the terminal is not considered; or
the RACH resource corresponding to the 4-step random access configured on the second BWP matches the capability of the terminal, and the RACH resource corresponding to the 2-step random access configured on the second BWP does not match the capability of the terminal.

In this implementation, in a case that the RACH resource corresponding to the 4-step random access configured on the second BWP matches the capability of the terminal, the 4-step random access can be preferentially selected or performed, or the 4-step random access can be preferentially confirmed to be available, so as to improve a success rate of the random access of the terminal.

For example, if the 2-step random access and the 4-step random access are configured on the second BWP, the terminal performs at least one of the following:

If the RACH resource corresponding to the 2-step random access (that is, a 2-step RACH resource) does not exceed the capability of the terminal, the terminal selects or performs a 2-step RACH on the second BWP, or the terminal considers that the 2-step RACH is available.

If the RACH resource corresponding to the 2-step random access does not exceed the capability of the terminal, the terminal selects or performs the 2-step RACH on the second BWP (or the terminal considers that the 2-step RACH is available); otherwise, the terminal selects or performs a 4-step RACH on the second BWP (or the terminal considers that the 4-step RACH is available), and in addition, the RACH resource or the monitoring configuration for the downlink channel that corresponds to the 4-step random access and is configured by the network side does not exceed the capability of the terminal. The network side ensures that neither the configured 4-step RACH nor a scheduled resource in a process of performing the 4-step RACH exceeds the capability of the terminal.

If the RACH resource corresponding to the 2-step random access does not exceed the capability of the terminal, and the RACH resource corresponding to the 4-step random access (that is, a 4-step RACH resource) does not exceed the capability of the terminal, the terminal selects or performs the 2-step RACH on the second BWP, or the terminal considers that the 2-step RACH is available.

If the RACH resource corresponding to the 2-step random access does not exceed the capability of the terminal, and the RACH resource corresponding to the 4-step random access exceeds the capability of the terminal, the terminal selects or performs the 2-step RACH on the second BWP, or the terminal considers that the 2-step RACH is available.

If the RACH resource corresponding to the 2-step random access exceeds the capability of the terminal, the terminal selects or performs the 4-step RACH on the second BWP, or the terminal considers that the 4-step RACH is available, or the terminal considers that the 2-step RACH is unavailable.

If the RACH resource corresponding to the 2-step random access exceeds the capability of the terminal, the terminal selects or performs the 4-step RACH on the second BWP (or the terminal considers that the 4-step RACH is available, or the terminal considers that the 2-step RACH is unavailable); otherwise, the terminal selects or performs the 2-step RACH on the second BWP (or the terminal considers that the 2-step RACH is available). In addition, a resource or a configuration for the downlink channel of the 2-step RACH configured by the network side does not exceed the capability of the terminal. The network side ensures that neither the configured 2-step RACH nor a scheduled resource in a process of performing the 2-step RACH exceeds the capability of the terminal.

If the RACH resource corresponding to the 2-step random access exceeds the capability of the terminal, and the RACH resource corresponding to the 4-step random access does not exceed the capability of the terminal, the terminal selects or performs the 4-step RACH on the second BWP, or the terminal considers that the 4-step RACH is available, or the terminal considers that the 2-step RACH is unavailable.

In addition, if the RACH resource corresponding to the 2-step random access exceeds the capability of the terminal, and the RACH resource corresponding to the 4-step random access exceeds the capability of the terminal, the terminal considers that a RACH configured on the second BWP is invalid or unavailable.

In some implementations, if a corresponding condition for selecting the 2-step RACH is satisfied, the 2-step RACH is selected or performed on the first BWP, the second BWP, or the third BWP. The corresponding condition for selecting the 2-step RACH is a condition defined by a protocol or configured by the network side, for example, measurement performance of the terminal is higher than a preset threshold.

In embodiments of this application, in the case that the first BWP satisfies the first condition, the terminal is switched to the second BWP, so that the terminal communicates on the second BWP, so as to improve communication performance of the terminal. In the case that the first BWP satisfies the first condition, the random access is initiated or the downlink channel is monitored on the second BWP, so that the terminal can initiate the RACH procedure or monitor the downlink channel on the second BWP, so as to improve the communication performance of the terminal. In addition, in the case that the target configuration on the first BWP does not match the capability of the terminal, the 4-step random access procedure is performed or the downlink channel corresponding to the 4-step random access procedure is monitored on the first BWP, to improve a success rate of the random access of the terminal, so as to improve the communication performance of the terminal.

FIG. 5 is a flowchart of a configuration method according to an embodiment of this application. As shown in FIG. 5, the method includes the following steps.

Step 501: A network side device sends configuration information to a terminal; where
the configuration information is used for, in a case that a network side configures 2-step random access on a first BWP, configuring 4-step random access for the first BWP; or
configuration content that the configuration information is used for satisfies at least one of the following:
a RACH resource corresponding to the 2-step random access configured on the first BWP matches a capability of the terminal;
a monitoring configuration for a downlink channel that corresponds to the 2-step random access configured on the first BWP matches the capability of the terminal;
a RACH resource corresponding to the 4-step random access configured on the first BWP matches the capability of the terminal; or
a monitoring configuration for the downlink channel that corresponds to the 4-step random access configured on the first BWP matches the capability of the terminal.

That the configuration information is used for, in a case that a network side configures 2-step random access on a first BWP, configuring 4-step random access for the first BWP may be understood as that, if the network side configures the 2-step random access on the first BWP, the 4-step random access is also configured on the first BWP by using the foregoing configuration information. The 2-step random access may be configured on the first BWP by using the foregoing configuration information, or may be configured by using other configuration information.

The a monitoring configuration for the downlink channel that corresponds to the 4-step random access configured on the first BWP matches the capability of the terminal may be that the network side ensures that the 4-step random access configured on the first BWP or the scheduled resource in the process of performing the 4-step random access matches the capability of the terminal, and performs configuration by using the configuration information.

For the foregoing 2-step random access and 4-step random access, and the foregoing resources or configurations that match the capability of the terminal, refer to corresponding descriptions in the embodiment shown in FIG. 4. Details are not described herein again.

Optionally, that the 2-step random access is configured on the first BWP includes at least one of the following:
a 2-step random access type is configured on the first BWP;
the RACH resource corresponding to the 2-step random access is configured on the first BWP; or
the monitoring configuration for the downlink channel that corresponds to the 2-step random access is configured on the first BWP; or
that the 4-step random access is configured on the first BWP includes at least one of the following:
configuring a 4-step random access type on the first BWP;
the RACH resource corresponding to the 4-step random access is configured on the first BWP; or
the monitoring configuration for the downlink channel that corresponds to the 4-step random access is configured on the first BWP.

In this embodiment of this application, because the 2-step random access and the 4-step random access are configured on the first BWP by using the configuration information, the terminal can initiate the 2-step random access or the 4-step random access on the first BWP, and fall back from the 2-step random access to the 4-step random access on the first BWP, to improve reliability of random access of the terminal, so as to improve communication performance of the terminal. In addition, because the configuration content on the first BWP that the configuration information is used for matches the capability of the terminal, reliability of random access of the terminal can be improved, to improve communication performance of the terminal.

It should be further noted that this embodiment is used as an implementation of the network side device corresponding to the embodiment shown in FIG. 4. For a specific implementation of this embodiment, refer to related descriptions of the embodiment shown in FIG. 4 to avoid repeated descriptions. Details are not described in this embodiment again.

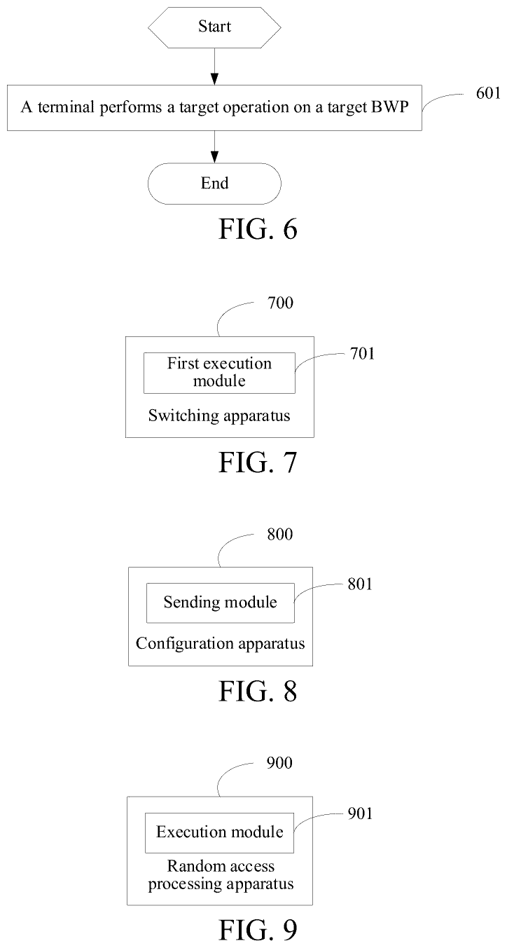

FIG. 6 is a flowchart of a random access processing method according to an embodiment of this application. As shown in FIG. 6, the method includes the following steps.

Step 601: A terminal performs a target operation on a target BWP, where the target operation includes at least one of the following:
in a case that 2-step random access is configured on the target BWP, selecting or performing the 2-step random access, or confirming that the 2-step random access is available;
in a case that 4-step random access is configured on the target BWP, selecting or performing the 4-step random access, or confirming that the 4-step random access is available;
in a case that the 2-step random access and the 4-step random access are configured on the target BWP, selecting or performing the 2-step random access, or confirming that the 2-step random access is available; or in the case that the 2-step random access and the 4-step random access are configured on the target BWP, selecting or performing the 4-step random access, or confirming that the 4-step random access is available.

The target BWP may be the first BWP, the second BWP, or the third BWP in the embodiment shown in FIG. 4. For a specific implementation, refer to corresponding descriptions in the embodiment shown in FIG. 4. Details are not described herein again.

Optionally, the in a case that the 2-step random access is configured on the target BWP, selecting or performing the 2-step random access, or confirming that the 2-step random access is available includes:
in a case that the 2-step random access is configured on the target BWP and a RACH resource corresponding to the 2-step random access configured on the target BWP matches a capability of the terminal, selecting or performing the 2-step random access, or confirming that the 2-step random access is available;
or
the in a case that 4-step random access is configured on the target BWP, selecting or performing the 4-step random access, or confirming that the 4-step random access is available includes:
in a case that the 4-step random access is configured on the target BWP and a RACH resource corresponding to the 4-step random access configured on the target BWP matches the capability of the terminal, selecting or performing the 4-step random access, or confirming that the 4-step random access is available; or
the in a case that the 2-step random access and the 4-step random access are configured on the target BWP, selecting or performing the 2-step random access, or confirming that the 2-step random access is available includes:
in a case that the 2-step random access and the 4-step random access are configured on the target BWP and the RACH resource corresponding to the 2-step random access configured on the target BWP matches the capability of the terminal, selecting or performing the 2-step random access, or confirming that the 2-step random access is available; or
the in the case that the 2-step random access and the 4-step random access are configured on the target BWP, selecting or performing the 4-step random access, or confirming that the 4-step random access is available includes:
in a case that the 2-step random access and the 4-step random access are configured on the target BWP and the RACH resource corresponding to the 2-step random access configured on the target BWP does not match the capability of the terminal, selecting or performing the 4-step random access, or confirming that the 4-step random access is available.

In this embodiment of this application, corresponding random access can be flexibly selected or performed, or the corresponding random access can be determined to be available through the target operation, to improve reliability of random access of the terminal, so as to improve communication performance of the terminal.

It should be further noted that this embodiment is used as an implementation of the terminal corresponding to the embodiment shown in FIG. 4. For a specific implementation of this embodiment, refer to related descriptions of the embodiment shown in FIG. 4 to avoid repeated descriptions. Details are not described in this embodiment again.

The following illustrates the method according to this embodiment of this application with reference to a plurality of embodiments.

### Embodiment 1

In this embodiment, a configuration of a RACH resource corresponding to 2-step random access (2-step RACH resource for short below) and BWP switching are mainly described. Details are as follows:

When a 2-step RACH is configured on a first BWP, to ensure a fallback mechanism of a terminal, that is, if the 2-step RACH resource exceeds a capability of the terminal, the terminal needs to fall back to the 2-step RACH or a 4-step RACH (where an application scenario includes: if both a 2-step RACH type and a separate initial BWP are configured) by using at least one of the following mechanisms:

### Solution 1: BWP Switching

Specifically, one of the following is included:

Solution 1.1: The terminal switches to a second BWP, where the second BWP includes a second UL BWP or a second DL BWP. Even if only a 2-step RACH resource on the uplink BWP exceeds the capability of the terminal, switching herein also includes an uplink or downlink BWP.

Solution 1.2: The terminal initiates a RACH procedure on the second UL BWP, or monitors a downlink channel (including a PDCCH or a PDSCH) on the second DL BWP.

It should be noted that, a difference between Solution 1.1 and Solution 1.2 is that, in Solution 1.2, the BWP is changed only for the RACH procedure, and in Solution 1.1, the BWP is switched, and is also switched for another corresponding operation, for example, the BWP is switched for RA-SDT/CG-SDT or another operation.

A difference between Solution 1.2 and Solution 1.1 is that, in Solution 1.1, the BWP is switched, and in Solution 1.2, the BWP is not switched. However, a BWP corresponding to the RACH procedure and an action of downlink monitoring changes, that is, a BWP corresponding to another action does not change.

For Solution 1.1 and Solution 1.2, the second BWP satisfies at least one of the following:
a 4-step RACH is configured on the second BWP;
a 2-step RACH configured on the second BWP does not exceed the capability of the terminal;
the 4-step RACH configured on the second BWP does not exceed the capability of the terminal; or
a resource of the downlink channel that is configured on the second BWP does not exceed the capability of the terminal.

For Solution 1.1, that the terminal switches to the second BWP includes at least one of the following:

Solution 1.1.2: If the 2-step RACH is configured on the second BWP, and a corresponding resource of the 2-step RACH does not exceed the capability of the terminal, the terminal switches to the second BWP. For example, if a 2-step RACH on the separate initial BWP falls within a capability range of the terminal, that is, does not exceed the capability of the UE, the separate initial BWP is switched to. In addition, an uplink BWP of the terminal is switched to the second BWP (where the second BWP herein includes only an uplink BWP).

Solution 1.1.2: If the 4-step RACH is configured on the second BWP, and a corresponding resource of the 4-step RACH does not exceed the capability of the terminal, the terminal switches to the second BWP. In addition, the uplink BWP of the terminal is switched to the second BWP (where the second BWP herein includes only an uplink BWP).

Solution 1.1.3: If the 4-step RACH is configured on the second BWP, the terminal switches to the second BWP. In addition, the uplink BWP of the terminal is switched to the second BWP (where the second BWP herein includes only an uplink BWP). A resource of a 4-step RACH or a configuration of a downlink channel that is configured by a network side does not exceed the capability of the terminal, or the network side ensures that neither the configured 4-step RACH nor a scheduled resource in a process of performing the 4-step RACH exceeds the capability of the terminal.

Solution 1.1.4: If the resource of the downlink channel configured on the second BWP does not exceed the capability of the terminal, the terminal switches to the second BWP. In addition, a downlink BWP of the terminal is switched to the second BWP (where the second BWP herein includes only a downlink BWP).

Solution 1.1.5: Otherwise, a third BWP is switched to. The uplink BWP of the terminal is switched to the third BWP (where the third BWP herein includes only an uplink BWP), or the downlink BWP of the terminal is switched to the third BWP (where the third BWP herein includes only a downlink BWP).

Solution 1.1.6: If no 4-step RACH is configured on the first BWP (regardless of whether the 2-step RACH is configured herein, or regardless of whether the configured 2-step RACH exceeds the capability of the UE), the terminal switches to the second BWP. In addition, the uplink BWP of the terminal is switched to the second BWP (where the second BWP herein includes only an uplink BWP), and the downlink BWP of the terminal is switched to the second BWP (where the second BWP herein includes only a downlink BWP). For example, if there is no 4-step RACH on the separate initial BWP, a legacy initial BWP is switched to.

It should be noted that, a main scenario of Solution 1.1.1 to Solution 1.1.4 is that other BWPs are switched to the legacy initial BWP or the separate initial BWP, and the Separate initial BWP is switched to the legacy initial BWP.

A main scenario of Solution 1.1.5 is that a network configures the Separate initial BWP for the terminal. Therefore, the second BWP in Solution 1.1.1 to Solution 1.1.4 corresponds to the separate initial BWP, and the third BWP in Solution 1.1.5 corresponds to an initial BWP.

Specifically, the third BWP satisfies at least one of the following:
a 4-step RACH is configured on the third BWP;
a 2-step RACH configured on the third BWP does not exceed the capability of the terminal;
the 4-step RACH configured on the third BWP does not exceed the capability of the terminal; or
a resource of the downlink channel that is configured on the third BWP does not exceed the capability of the terminal.

For Solution 1.2, that the terminal initiates a RACH procedure on the second UL BWP, or monitors a downlink channel on the second DL BWP includes at least one of the following:

Solution 1.2.1: If the 2-step RACH is configured on the second BWP, and the corresponding resource of the 2-step RACH does not exceed the capability of the terminal, the RACH procedure is initiated on the second UL BWP, or the downlink channel is monitored on the second DL BWP. For example, if the 2-step RACH on the separate initial BWP falls within the capability range of the terminal, that is, does not exceed the capability of the UE, the RACH procedure is initiated on the second UL BWP, or the downlink channel is monitored on the second DL BWP.

Solution 1.2.2: If the 4-step RACH is configured on the second BWP, and the corresponding resource of the 4-step RACH does not exceed the capability of the terminal, the terminal initiates the RACH procedure on the second UL BWP, or monitors the downlink channel on the second DL BWP.

Solution 1.2.3: If the 4-step RACH is configured on the second BWP, the terminal initiates the RACH procedure on the second UL BWP, or monitors the downlink channel on the second DL BWP. The resource of the 4-step RACH or the configuration of the downlink channel that is configured by the network side does not exceed the capability of the terminal, or the network side ensures that neither the configured 4-step RACH nor the scheduled resource in the process of performing the 4-step RACH exceeds the capability of the terminal.

Solution 1.2.4: If the resource of the downlink channel that is configured on the second BWP does not exceed the capability of the terminal, the terminal initiates the RACH procedure on the second UL BWP, or monitors the downlink channel on the second DL BWP.

Solution 1.2.5: Otherwise, the terminal initiates the RACH procedure on a third UL BWP, or monitors the downlink channel on a third DL BWP.

Solution 1.2.6: If no 4-step RACH is configured on the first BWP (regardless of whether the 2-step RACH is configured herein, or regardless of whether the configured 2-step RACH exceeds the capability of the UE), the terminal initiates the RACH procedure on the second UL BWP, or monitors the downlink channel on the second DL BWP. For example, if there is no 4-step RACH on the separate initial BWP, the terminal initiates the RACH procedure on the second UL BWP, or monitors the downlink channel on the second DL BWP.

It should be noted that, a main scenario of Solution 1.2.1 to Solution 1.2.4 is that other BWPs are switched to the legacy initial BWP or the separate initial BWP, and the Separate initial BWP is switched to the legacy initial BWP.

A main scenario of Solution 1.2.5 is that the network configures the Separate initial BWP for the terminal. Therefore, the second BWP in Solution 1.2.1 to Solution 1.2.4 corresponds to the separate initial BWP, and the third BWP in Solution 1.2.5 corresponds to an initial BWP.

Specifically, the third BWP satisfies at least one of the following:
the 4-step RACH is configured on the third BWP;
the 2-step RACH configured on the third BWP does not exceed the capability of the terminal;
the 4-step RACH configured on the third BWP does not exceed the capability of the terminal; or
the resource of the downlink channel that is configured on the third BWP does not exceed the capability of the terminal.

### Solution 2: Restricting a Configuration of the Network Side

If the 2-step RACH configured on the first BWP exceeds the capability of the terminal, the terminal performs the 4-step RACH on the first BWP.

Optionally, when configuring the 2-step RACH on the first BWP, the network side also needs to configure the 4-step RACH.

Optionally, a resource or a configuration of the downlink channel of the 4-step RACH configured by the network side does not exceed the capability of the terminal.

Optionally, the network side ensures that neither the configured 4-step RACH nor a scheduled resource in a process of performing the 4-step RACH exceeds the capability of the terminal.

Optionally, if the 4-step RACH on the first BWP exceeds the capability of the terminal, the terminal performs BWP switching according to Solution 1.

### For Solution 1 and Solution 2:

that the network side configures the 2-step/4-step RACH includes at least one of the following:
configuring a 2-step/4-step RACH type; or
configuring a resource corresponding to the 2-step/4-step RACH.

The 2-step RACH resource includes at least one of the following:
a MsgA PUSCH resource; or
a MsgB PDSCH resource.

The capability of the terminal includes at least one of the following:
an RF bandwidth, a baseband bandwidth, an operating bandwidth of the terminal,
a quantity of antennas, and the like.

The first BWP includes at least one of the following:
an active BWP;
a configured BWP;
a deactivated BWP;
a Separate initial BWP, specifically, another initial BWP different from the legacy initial BWP, for example, a RedCap specific initial BWP;
a BWP including a CD-SSB;
a BWP including an NCD-SSB;
a BWP including a CD-SSB or an NCD-SSB;
a BWP including a Coreset #0;
a first active BWP (First active BWP);
a first preset BWP, specifically, which is defined by a protocol or configured by the network side, for example, the protocol specifies or the network side configures a BWP used for a 4-step RACH or for fallback from a 2-step RACH to the 4-step RACH;
a Default/fallback BWP, specifically, a Default/fallback BWP used for the 4-step RACH or for fallback from the 2-step RACH to the 4-step RACH;
a BWP including a first resource, where the first resource includes at least one of the following:
the RACH resource corresponding to the 4-step RACH; or
the RACH resource corresponding to the 2-step RACH, where the RACH resource corresponding to the configured 2-step RACH does not exceed the capability of the terminal; or
a BWP for performing a first operation, where the first operation includes at least one of the following:
system information receiving, Paging monitoring, PEI monitoring, SSB receiving, a RACH, measurement of a CD-SSB, cell selection and reselection, camping, and SDT, where the SDT includes RA-SDT, CG-SDT, subsequent transmission of the RA-SDT, or subsequent transmission of the CG-SDT.

The second BWP or the third BWP includes at least one of the following:
an initial BWP;
a Separate initial BWP, specifically, another initial BWP different from the legacy initial BWP, for example, a RedCap specific initial BWP;
a BWP including a CD-SSB;
a BWP including an NCD-SSB;
a BWP including a CD-SSB or an NCD-SSB;
a BWP including a Coreset #0;
a first active BWP;
a second preset BWP, specifically, which is defined by a protocol or configured by the network side, for example, the protocol specifies or the network side configures a BWP used for a 4-step RACH or for fallback from a 2-step RACH to the 4-step RACH;
a Default/fallback BWP, specifically, a Default/fallback BWP used for the 4-step RACH or for fallback from the 2-step RACH to the 4-step RACH;
a BWP including a first resource, where the first resource includes at least one of the following:
the RACH resource corresponding to the 4-step RACH; or
the RACH resource corresponding to the 2-step RACH, where the RACH resource corresponding to the configured 2-step RACH does not exceed the capability of the terminal; or
a BWP for performing a second operation, where the second operation includes at least one of the following:
SI receiving, Paging monitoring, PEI monitoring, SSB receiving, a RACH, measurement of a CD-SSB, cell selection and reselection, camping, and SDT, where the SDT includes RA-SDT, CG-SDT, subsequent transmission of the RA-SDT, or subsequent transmission of the CG-SDT.

### Embodiment 2

In this embodiment, a resource configuration corresponding to the 2-step RACH and BWP switching are mainly described. Details are as follows:

When monitoring on the downlink channel (specifically, including monitoring on a PDCCH/PDSCH channel) is configured on the first BWP, to ensure a fallback mechanism of the terminal, that is, if the configured monitoring on the downlink channel exceeds the capability of the terminal, the terminal needs to fall back to monitoring on the downlink channel that does not exceed the capability of the terminal by using at least one of the following mechanisms:

### Solution 1: BWP Switching

Specifically, one of the following is included:

Solution 1.1: The terminal switches to a second BWP, where the second BWP includes a second UL BWP or a second DL BWP. Even if monitoring on only the downlink channel on the downlink BWP exceeds the capability of the terminal, switching herein also includes an uplink or downlink BWP.

Solution 1.2: The terminal initiates a RACH procedure on the second UL BWP, or monitors a downlink channel on the second DL BWP.

Other details are similar to those of Embodiment 1.

### Solution 2: Restricting a Configuration of the Network Side

If downlink channel monitoring corresponding to the 2-step RACH configured on the first BWP exceeds the capability of the terminal, the terminal performs a 4-step RACH on the first BWP or performs downlink channel monitoring corresponding to the 4-step RACH.

Optionally, when configuring the downlink channel monitoring corresponding to the 2-step RACH on the first BWP, the network side also needs to configure the 4-step RACH or perform the downlink channel monitoring corresponding to the 4-step RACH. In other words, if the downlink channel monitoring corresponding to the 2-step RACH exceeds the capability of the terminal, the terminal performs the 4-step RACH or performs the downlink channel monitoring corresponding to the 4-step RACH on the first BWP.

Optionally, a resource or a configuration of the downlink channel of the 4-step RACH configured by the network side does not exceed the capability of the terminal.

Optionally, the network side ensures that neither the configured 4-step RACH nor a scheduled resource in a process of performing the 4-step RACH exceeds the capability of the terminal.

It should be noted that this embodiment and the embodiment 1 may be separately implemented, or this embodiment may also be used as a supplement to the technical solution of Embodiment 1.

### Embodiment 3

In this embodiment, selection of a 2-step RACH type and selection of a RACH resource are mainly described. Details are as follows:

For different configuration cases, at least one of the following is specifically included:

If a 2-step RACH is configured on a target BWP, and a RACH resource corresponding to 2-step random access (2-step RACH resource for short below) does not exceed the capability of the terminal, the terminal selects or performs the 2-step RACH on the target BWP, or the terminal considers that the 2-step RACH is available.

If a 4-step RACH is configured on the target BWP, and a RACH resource corresponding to 4-step random access (4-step RACH resource for short below) does not exceed the capability of the terminal, the terminal selects or performs the 4-step RACH on the target BWP, or the terminal considers that the 4-step RACH is available.

If the 2-step RACH is configured on the target BWP, the terminal selects or performs the 2-step RACH on the target BWP, or the terminal considers that the 2-step RACH is available. In addition, a resource or a configuration for a downlink channel of the 2-step RACH configured by the network side does not exceed the capability of the terminal. The network side ensures that neither the configured 2-step RACH nor a scheduled resource in a process of performing the 2-step RACH exceeds the capability of the terminal.

If the 4-step RACH is configured on the target BWP, the terminal selects or performs the 4-step RACH on the target BWP, or the terminal considers that the 4-step RACH is available. In addition, a resource or a configuration for a downlink channel of the 4-step RACH configured by the network side does not exceed the capability of the terminal. The network side ensures that neither the configured 4-step RACH nor a scheduled resource in a process of performing the 4-step RACH exceeds the capability of the terminal.

If the 2-step RACH and the 4-step RACH are configured on the target BWP, at least one of the following is included:

If the RACH resource corresponding to the 2-step random access (that is, a 2-step RACH resource) does not exceed the capability of the terminal, the terminal selects or performs a 2-step RACH on the second BWP, or the terminal considers that the 2-step RACH is available.

If the RACH resource corresponding to the 2-step random access does not exceed the capability of the terminal, the terminal selects or performs the 2-step RACH on the second BWP (or the terminal considers that the 2-step RACH is available); otherwise, the terminal selects or performs a 4-step RACH on the second BWP (or the terminal considers that the 4-step RACH is available), and in addition, the RACH resource or the monitoring configuration for the downlink channel that corresponds to the 4-step random access and is configured by the network side does not exceed the capability of the terminal. The network side ensures that neither the configured 4-step RACH nor a scheduled resource in a process of performing the 4-step RACH exceeds the capability of the terminal.

If the RACH resource corresponding to the 2-step random access does not exceed the capability of the terminal, and the RACH resource corresponding to the 4-step random access (that is, a 4-step RACH resource) does not exceed the capability of the terminal, the terminal selects or performs the 2-step RACH on the second BWP, or the terminal considers that the 2-step RACH is available.

If the RACH resource corresponding to the 2-step random access does not exceed the capability of the terminal, and the RACH resource corresponding to the 4-step random access exceeds the capability of the terminal, the terminal selects or performs the 2-step RACH on the second BWP, or the terminal considers that the 2-step RACH is available.

If the RACH resource corresponding to the 2-step random access exceeds the capability of the terminal, the terminal selects or performs the 4-step RACH on the second BWP, or the terminal considers that the 4-step RACH is available, or the terminal considers that the 2-step RACH is unavailable.

If the RACH resource corresponding to the 2-step random access exceeds the capability of the terminal, the terminal selects or performs the 4-step RACH on the second BWP (or the terminal considers that the 4-step RACH is available, or the terminal considers that the 2-step RACH is unavailable); otherwise, the terminal selects or performs the 2-step RACH on the second BWP (or the terminal considers that the 2-step RACH is available). In addition, a resource or a configuration for the downlink channel of the 2-step RACH configured by the network side does not exceed the capability of the terminal. The network side ensures that neither the configured 2-step RACH nor a scheduled resource in a process of performing the 2-step RACH exceeds the capability of the terminal.

If the RACH resource corresponding to the 2-step random access exceeds the capability of the terminal, and the RACH resource corresponding to the 4-step random access does not exceed the capability of the terminal, the terminal selects or performs the 4-step RACH on the second BWP, or the terminal considers that the 4-step RACH is available, or the terminal considers that the 2-step RACH is unavailable.

In addition, if the RACH resource corresponding to the 2-step random access exceeds the capability of the terminal, and the RACH resource corresponding to the 4-step random access exceeds the capability of the terminal, the terminal considers that a RACH configured on the second BWP is invalid or unavailable.

That the 2-step RACH is selected or performed on the first BWP, the second BWP, or the third BWP specifically includes:
the terminal selects a 2-step RACH type;
the terminal selects a 2-step RACH resource; and
the terminal performs a RACH procedure by using the 2-step RACH resource.

In addition, if a corresponding condition for selecting the 2-step RACH is satisfied, the 2-step RACH is selected or performed on the first BWP, the second BWP, or the third BWP. The corresponding condition of the 2-step RACH is a condition defined by a protocol or configured by the network side, for example, measurement performance of the terminal is higher than a preset threshold.

That the 4-step RACH is selected or performed on the first BWP, the second BWP, or the third BWP specifically includes:
the terminal selects a 4-step RACH type;
the terminal selects a 4-step RACH resource; and
the terminal performs a RACH procedure by using the 4-step RACH resource.

It should be noted that this embodiment may be independently used, that is, to determine how to select a RACH type and select an RACH resource or an RACH resource set in a case that the 2-step RACH or the 4-step RACH is configured on a BWP.

Alternatively, this embodiment is used in combination with the solution in Embodiment 1 or Embodiment 2. To be specific, the target BWP is first switched to according to the solution in Embodiment 1 or Embodiment 2, and how to select a RACH type and select an RACH resource or an RACH resource set in a case that the 2-step RACH or the 4-step RACH is configured on the BWP is determined.

An execution entity of a switching method provided in embodiments of this application may be a switching apparatus. An example in which the switching apparatus performs the switching method is used in an embodiment of this application to describe the switching apparatus provided in embodiments of this application.

FIG. 7 is a diagram of a structure of a switching apparatus according to an embodiment of this application. As shown in FIG. 7, the switching apparatus 700 includes:
a first execution module 710, configured to perform a first operation in a case that a first bandwidth part BWP satisfies a first condition, where the first condition includes at least one of the following: a target configuration on the first BWP does not match a capability of the terminal, no 4-step random access is configured on the first BWP, or a random access failure occurs, where the target configuration includes at least one of the following: a random access channel RACH resource or a monitoring configuration for a downlink channel; and
the first operation includes:
switching to the second BWP; or
initiating random access or monitoring the downlink channel on the second BWP; or
on the first BWP, performing a 4-step random access procedure or monitoring a downlink channel corresponding to the 4-step random access procedure, where the first condition is that the target configuration on the first BWP does not match the capability of the terminal.

Optionally, that a target configuration does not match a capability of the terminal includes:
the target configuration exceeds the capability of the terminal; or
the target configuration exceeds capabilities of some terminals of a terminal type, where the terminal type is a terminal type to which the terminal belongs.

Optionally, performing the first operation includes:
the terminal performs the first operation in a case that a second condition is satisfied, where the second condition includes at least one of the following:
2-step random access is configured on the second BWP;
a RACH resource corresponding to the 2-step random access configured on the second BWP matches the capability of the terminal;
4-step random access is configured on the second BWP;
a RACH resource corresponding to the 4-step random access configured on the second BWP matches the capability of the terminal; or
a monitoring configuration for the downlink channel that is configured on the second BWP matches the capability of the terminal; and
the first operation includes:
switching to the second BWP; or
initiating the random access or monitoring the downlink channel on the second BWP.

Optionally, that the 2-step random access is configured on the second BWP may include at least one of the following:
a 2-step random access type is configured on the second BWP;
the RACH resource corresponding to the 2-step random access is configured on the second BWP; or
a monitoring configuration for the downlink channel that corresponds to the 2-step random access is configured on the second BWP; or
that 4-step random access is configured on the second BWP includes at least one of the following:
a 4-step random access type is configured on the second BWP;
the RACH resource corresponding to the 4-step random access is configured on the second BWP; or
a monitoring configuration for the downlink channel that corresponds to the 4-step random access is configured on the second BWP.

In one embodiment, the apparatus further includes:
a second execution module, configured for a terminal to perform a second operation in a case that the first BWP satisfies the first condition and the second BWP does not satisfy the second condition, where the second operation includes:
switching to a third BWP; or
initiating a RACH procedure or monitoring the downlink channel on the third BWP.

Optionally, the second BWP includes an additional initial BWP; or
the third BWP includes an initial BWP.

Optionally, the third BWP satisfies a third condition, and the third condition includes:
the 2-step random access is configured on the third BWP;
a RACH resource corresponding to the 2-step random access configured on the third BWP matches the capability of the terminal;
the 4-step random access is configured on the third BWP;
a RACH resource corresponding to the 4-step random access configured on the third BWP matches the capability of the terminal; and
a monitoring configuration for the downlink channel that is configured on the third BWP matches the capability of the terminal.

Optionally, the first BWP includes at least one of the following: a first uplink BWP or a first downlink BWP; or
the third BWP includes at least one of the following: a third uplink BWP or a third downlink BWP; or
the switching to a third BWP includes at least one of the following:
switching to the third uplink BWP; or
switching to the third downlink BWP.

Optionally, the first BWP includes at least one of the following: a first uplink BWP or a first downlink BWP; or
the second BWP includes at least one of the following: a second uplink BWP or a second downlink BWP; or
the switching to a second BWP includes at least one of the following:
switching to the second uplink BWP; or
switching to the second downlink BWP.

Optionally, the RACH resource includes at least one of the following:
the RACH resource corresponding to the 2-step random access; or
the RACH resource corresponding to the 4-step random access.

Optionally, the performing a 4-step random access procedure on the first BWP includes:
in a case that the RACH resource includes the RACH resource corresponding to the 2-step random access and the 4-step random access is configured on the first BWP, performing, by the terminal, the 4-step random access procedure on the first BWP; or
the monitoring, on the first BWP, a downlink channel corresponding to the 4-step random access procedure includes:
in a case that the monitoring configuration for the downlink channel is the monitoring configuration for the downlink channel that corresponds to the 2-step random access and a monitoring configuration for the downlink channel that corresponds to the 4-step random access is configured on the first BWP, monitoring, on the first BWP, the downlink channel corresponding to the 4-step random access.

In one embodiment, the apparatus further includes:
an obtaining module, configured to obtain configuration information, where the configuration information is used for configuring at least one of the following:
configuring the 2-step random access and the 4-step random access on the first BWP;
configuring, on the first BWP, the RACH resource corresponding to the 2-step random access and the RACH resource corresponding to the 4-step random access; or
configuring, on the first BWP, the monitoring configuration for the downlink channel that corresponds to the 2-step random access and the monitoring configuration for the downlink channel that corresponds to the 4-step random access.

Optionally, the RACH resource corresponding to the 4-step random access configured on the first BWP matches the capability of the terminal; or
the monitoring configuration for the downlink channel that corresponds to the 4-step random access configured on the first BWP matches the capability of the terminal.

Optionally, the capability of the terminal includes at least one of the following:
a radio frequency RF bandwidth, a baseband bandwidth, an operating bandwidth, or a quantity of antennas.

Optionally, the first BWP includes at least one of the following:
an active BWP, a configured BWP, a deactivated BWP, an additional initial BWP, a BWP including a cell defining synchronization signal block CD-SSB, a BWP including a non-cell defining synchronization signal block NCD-SSB, a BWP including a control resource set CORESET #0, a first preset BWP, a default BWP, a fallback BWP, a BWP on which the RACH resource corresponding to the 4-step random access is configured, a BWP on which the RACH resource corresponding to the 2-step random access is configured, or a BWP on which a third operation is performed, where the third operation includes at least one of the following:
receiving a system information SI, monitoring paging, monitoring a paging early indication PEI, receiving an SSB, random access, measuring a CD-SSB, cell selection, cell reselection, camping, or small data transmission SDT.

Optionally, the second BWP includes at least one of the following:
an initial BWP, an additional initial BWP, a BWP including a CD-SSB, a BWP including an NCD-SSB, a BWP including a CORESET #0, a second preset BWP, a default BWP, a backoff BWP, a BWP on which the RACH resource corresponding to the 4-step random access is configured, a BWP on which the RACH resource corresponding to the 2-step random access is configured, or a BWP on which a fourth operation is performed, where the fourth operation includes at least one of the following:
receiving a system information SI, monitoring paging, monitoring a paging early indication PEI, receiving an SSB, random access, measuring a CD-SSB, cell selection, cell reselection, camping, or small data transmission SDT.

Optionally, in a case that the terminal switches to the second BWP or the terminal initiates the RACH procedure on the second BWP, the terminal performs at least one of the following for the second BWP:
in a case that the 2-step random access is configured on the second BWP, selecting or performing the 2-step random access, or confirming that the 2-step random access is available;
in a case that the 4-step random access is configured on the second BWP, selecting or performing the 4-step random access, or confirming that the 4-step random access is available; or
in a case that the 2-step random access and the 4-step random access are configured on the second BWP, selecting or performing the 2-step random access, or confirming that the 2-step random access is available; or in the case that the 2-step random access and the 4-step random access are configured on the second BWP, selecting or performing the 4-step random access, or confirming that the 4-step random access is available.

Optionally, the in a case that the 2-step random access is configured on the second BWP, selecting or performing the 2-step random access, or confirming that the 2-step random access is available includes:
in a case that the 2-step random access is configured on the second BWP and the RACH resource corresponding to the 2-step random access configured on the second BWP matches the capability of the terminal, selecting or performing the 2-step random access, or confirming that the 2-step random access is available;
or
the in a case that the 4-step random access is configured on the second BWP, selecting or performing the 4-step random access, or confirming that the 4-step random access is available includes:
in a case that the 4-step random access is configured on the second BWP and the RACH resource corresponding to the 4-step random access configured on the second BWP matches the capability of the terminal, selecting or performing the 4-step random access, or confirming that the 4-step random access is available; or
the in a case that the 2-step random access and the 4-step random access are configured on the second BWP, selecting or performing the 2-step random access, or confirming that the 2-step random access is available includes:
in a case that the 2-step random access and the 4-step random access are configured on the second BWP and the RACH resource corresponding to the 2-step random access configured on the second BWP matches the capability of the terminal, selecting or performing the 2-step random access, or confirming that the 2-step random access is available; or
the in the case that the 2-step random access and the 4-step random access are configured on the second BWP, selecting or performing the 4-step random access, or confirming that the 4-step random access is available includes:
in a case that the 2-step random access and the 4-step random access are configured on the second BWP and the RACH resource corresponding to the 2-step random access configured on the second BWP does not match the capability of the terminal, selecting or performing the 4-step random access, or confirming that the 4-step random access is available.

The foregoing switching apparatus can improve communication performance of the terminal.

The switching apparatus in this embodiment of this application may be an electronic device, for example, an electronic device having an operating system, or may be a component in an electronic device, for example, an integrated circuit or a chip. The electronic device may be a terminal, or may be a device other than the terminal. For example, the terminal may include but is not limited to a type of the terminal 11 listed above, and the another device may be a server, a network attached storage (Network Attached Storage, NAS), or the like. This is not specifically limited in this embodiment of this application.

The switching apparatus provided in this embodiment of this application can implement processes implemented in the foregoing method embodiment in FIG. 4 and achieve the same technical effects. To avoid repetition, details are not described herein again.

An execution entity of a configuration method provided in embodiments of this application may be a configuration apparatus. An example in which the configuration apparatus performs the configuration method is used in an embodiment of this application to describe the configuration apparatus provided in embodiments of this application.

FIG. 8 is a diagram of a structure of a configuration apparatus according to an embodiment of this application. As shown in FIG. 8, the configuration apparatus 800 includes:
a sending module 801, configured to send configuration information to a terminal, where
the configuration information is used for, in a case that a network side configures 2-step random access on a first bandwidth part BWP, configuring 4-step random access for the first BWP; or
configuration content that the configuration information is used for satisfies at least one of the following:
a RACH resource corresponding to the 2-step random access configured on the first BWP matches a capability of the terminal;
a monitoring configuration for a downlink channel that corresponds to the 2-step random access configured on the first BWP matches the capability of the terminal;
a RACH resource corresponding to the 4-step random access configured on the first BWP matches the capability of the terminal; or
a monitoring configuration for the downlink channel that corresponds to the 4-step random access configured on the first BWP matches the capability of the terminal.

Optionally, that the 2-step random access is configured on the first BWP includes at least one of the following:
a 2-step random access type is configured on the first BWP;
the RACH resource corresponding to the 2-step random access is configured on the first BWP; or
the monitoring configuration for the downlink channel that corresponds to the 2-step random access is configured on the first BWP; or
that the 4-step random access is configured on the first BWP includes at least one of the following:
configuring a 4-step random access type on the first BWP;
the RACH resource corresponding to the 4-step random access is configured on the first BWP; or
the monitoring configuration for the downlink channel that corresponds to the 4-step random access is configured on the first BWP.

The foregoing configuration apparatus can improve communication performance of the terminal.

The configuration apparatus in this embodiment of this application may be an electronic device, for example, an electronic device having an operating system, or may be a component in an electronic device, for example, an integrated circuit or a chip. The electronic device may be a terminal or a network side device.

The configuration apparatus provided in this embodiment of this application can implement processes implemented in the foregoing method embodiment shown in FIG. 5 and achieve the same technical effects. To avoid repetition, details are not described herein again.

An execution entity of a random access processing method provided in embodiments of this application may be a random access processing apparatus. An example in which the random access processing apparatus performs the random access processing method is used in an embodiment of this application to describe the random access processing apparatus provided in embodiments of this application.

FIG. 9 is a diagram of a structure of a random access processing apparatus according to an embodiment of this application. As shown in FIG. 9, the random access processing apparatus 900 includes:
an execution module 901, configured to perform a target operation on a target BWP, where the target operation includes at least one of the following:
in a case that 2-step random access is configured on the target BWP, selecting or performing the 2-step random access, or confirming that the 2-step random access is available;
in a case that 4-step random access is configured on the target BWP, selecting or performing the 4-step random access, or confirming that the 4-step random access is available; or
in a case that the 2-step random access and the 4-step random access are configured on the target BWP, selecting or performing the 2-step random access, or confirming that the 2-step random access is available; or in the case that the 2-step random access and the 4-step random access are configured on the target BWP, selecting or performing the 4-step random access, or confirming that the 4-step random access is available.

Optionally, the in a case that the 2-step random access is configured on the target BWP, selecting or performing the 2-step random access, or confirming that the 2-step random access is available includes:
in a case that the 2-step random access is configured on the target BWP and a RACH resource corresponding to the 2-step random access configured on the target BWP matches a capability of the terminal, selecting or performing the 2-step random access, or confirming that the 2-step random access is available; or
the in a case that 4-step random access is configured on the target BWP, selecting or performing the 4-step random access, or confirming that the 4-step random access is available includes:
in a case that the 4-step random access is configured on the target BWP and a RACH resource corresponding to the 4-step random access configured on the target BWP matches the capability of the terminal, selecting or performing the 4-step random access, or confirming that the 4-step random access is available; or
the in a case that the 2-step random access and the 4-step random access are configured on the target BWP, selecting or performing the 2-step random access, or confirming that the 2-step random access is available includes:
in a case that the 2-step random access and the 4-step random access are configured on the target BWP and the RACH resource corresponding to the 2-step random access configured on the target BWP matches the capability of the terminal, selecting or performing the 2-step random access, or confirming that the 2-step random access is available; or
the in the case that the 2-step random access and the 4-step random access are configured on the target BWP, selecting or performing the 4-step random access, or confirming that the 4-step random access is available includes:
in a case that the 2-step random access and the 4-step random access are configured on the target BWP and the RACH resource corresponding to the 2-step random access configured on the target BWP does not match the capability of the terminal, selecting or performing the 4-step random access, or confirming that the 4-step random access is available.

The foregoing random access processing apparatus can improve communication performance of the terminal.

The random access processing apparatus in this embodiment of this application may be an electronic device, for example, an electronic device having an operating system, or may be a component in an electronic device, for example, an integrated circuit or a chip. The electronic device may be a terminal, or may be a device other than the terminal. For example, the terminal may include but is not limited to a type of the terminal 11 listed above, and the another device may be a server, a network attached storage (Network Attached Storage, NAS), or the like. This is not specifically limited in this embodiment of this application.

The random access processing apparatus provided in this embodiment of this application can implement processes implemented in the foregoing method embodiment in FIG. 6 and achieve the same technical effects. To avoid repetition, details are not described herein again.

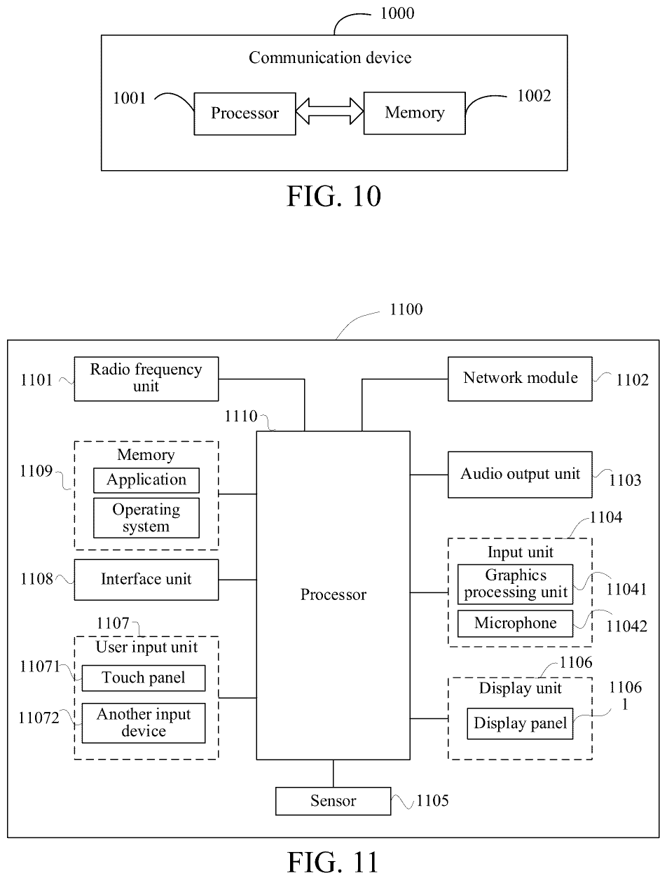

As shown in FIG. 10, an embodiment of this application further provides a communication device 1000, including a processor 1001 and a memory 1002. The memory 1002 stores a program or instructions runnable on the processor 1001. For example, in a case that the communication device 1000 is a terminal, the program or the instructions, when executed by the processor 1001, implement steps in the foregoing embodiments of the switching method or the random access processing method, and achieve the same technical effects. When the communication device 1000 is a network side device, the program or instructions, when executed by the processor 1001, implement steps in the foregoing embodiments of the configuration method, and achieve the same technical effects. To avoid repetition, details are not described herein again.

An embodiment of this application further provides a terminal, including a processor and a communication interface. The processor is configured to or the communication interface is configured to perform a first operation in a case that a first bandwidth part BWP satisfies a first condition, where the first condition includes at least one of the following: a target configuration on the first BWP does not match a capability of the terminal, no 4-step random access is configured on the first BWP, or a random access failure occurs, where the target configuration includes at least one of the following: a random access channel RACH resource or a monitoring configuration for a downlink channel; and the first operation includes: switching to a second BWP; or initiating random access or monitoring the downlink channel on the second BWP; or on the first BWP, performing a 4-step random access procedure or monitoring a downlink channel corresponding to the 4-step random access procedure, where the first condition is that the target configuration on the first BWP does not match the capability of the terminal; or the processor is configured to or the communication interface is configured to perform a target operation on a target BWP, where the target operation includes at least one of the following: in a case that 2-step random access is configured on the target BWP, selecting or performing the 2-step random access, or confirming that the 2-step random access is available; in a case that 4-step random access is configured on the target BWP, selecting or performing the 4-step random access, or confirming that the 4-step random access is available; in a case that the 2-step random access and the 4-step random access are configured on the target BWP, selecting or performing the 2-step random access, or confirming that the 2-step random access is available; or in the case that the 2-step random access and the 4-step random access are configured on the target BWP, selecting or performing the 4-step random access, or confirming that the 4-step random access is available.

An embodiment of this application further provides a terminal, including a processor and a communication interface, where the communication interface is coupled to the processor, and the processor is configured to run a program or instructions, to implement the steps in the method embodiments shown in FIG. 4 or FIG. 6. The terminal embodiment corresponds to the foregoing terminal side method embodiment. Implementation processes and implementation methods of the foregoing method embodiments may all be applied to the terminal embodiment, and the same technical effects can be achieved. Specifically, FIG. 11 is a schematic diagram of a hardware structure of a terminal according to an embodiment of this application.

The terminal 1100 includes, but is not limited to, at least some components such as a radio frequency unit 1101, a network module 1102, an audio output unit 1103, an input unit 1104, a sensor 1105, a display unit 1106, a user input unit 1107, an interface unit 1108, a memory 1109, and a processor 1110.

A person skilled in the art may understand that the terminal 1100 may further include a power supply (such as a battery) for supplying power to the components. The power supply may be logically connected to the processor 1110 by a power management system, thereby implementing functions such as charging, discharging, and power consumption management by using the power management system. The terminal structure shown in FIG. 11 does not constitute a limitation on the terminal, and the terminal may include more or fewer components than shown, or combine some components, or have different component arrangements. Details are not described herein again.

It should be understood that in this embodiment of this application, the input unit 1104 may include a graphics processing unit (Graphics Processing Unit, GPU) 11041 and a microphone 11042. The graphics processing unit 11041 processes image data of a static picture or a video that is obtained by an image acquisition device (for example, a camera) in a video acquisition mode or an image acquisition mode. The display unit 1106 may include a display panel 11061, and the display panel 11061 may be configured by using a liquid crystal display, an organic light-emitting diode, or the like. The user input unit 1107 includes at least one of a touch panel 11071 and another input device 11072. The touch panel 11071 is also referred to as a touch screen. The touch panel 11071 may include two parts: a touch detection apparatus and a touch controller. The another input device 11072 may include, but is not limited to, a physical keyboard, a functional key (such as a volume control key or a switch key), a track ball, a mouse, and a joystick, which are not repeated herein.

In this embodiment of this application, the radio frequency unit 1101 receives downlink data from a network side device and then transmits the data to the processor 1110 for processing. In addition, the radio frequency unit 1101 may send uplink data to the network side device. Generally, the radio frequency unit 1101 includes but is not limited to an antenna, an amplifier, a transceiver, a coupler, a low noise amplifier, a duplexer, and the like.

The memory 1109 may be configured to store software programs or instructions and various data. The memory 1109 may mainly include a first storage area for storing a program or an instruction and a second storage area for storing data, where the first storage area may store an operating system, an application program or an instruction required for at least one function (such as a sound playing function and an image playing function), and the like. Moreover, the memory 1109 may include a volatile memory or a non-volatile memory. The non-volatile memory may be a read-only memory (Read-Only Memory, ROM), a programmable read-only memory (Programmable ROM, PROM), an erasable programmable read-only memory (Erasable PROM, EPROM), an electrically erasable programmable read-only memory (Electrically EPROM, EEPROM), or a flash memory. The volatile memory may be a random access memory (Random Access Memory, RAM), a static random access memory (static RAM, SRAM), a dynamic random access memory (dynamic RAM, DRAM), a synchronous dynamic random access memory (Synchronous DRAM, SDRAM), a double data rate synchronous dynamic random access memory (Double Data Rate SDRAM, DDRSDRAM), an enhanced synchronous dynamic random access memory (Enhanced SDRAM, ESDRAM), a synchlink dynamic random access memory (Synchlink DRAM, SLDRAM), or a direct rambus random access memory (Direct Rambus RAM, DRRAM). The memory 1109 in this embodiment of this application includes, but is not limited to, these memories and any other suitable types.

The processor 1110 may include one or more processing units. Optionally, the processor 1110 integrates an application processor and a modem processor. The application processor mainly processes operations related to an operating system, a user interface, an application, and the like. The modem processor mainly processes wireless communication signals, and is, for example, a baseband processor. It may be understood that the foregoing modem may not be integrated into the processor 1110.

In an embodiment,
the processor 1110 or the radio frequency unit 1101 is configured to perform a first operation in a case that a first BWP satisfies a first condition, where the first condition includes at least one of the following: a target configuration on the first BWP does not match a capability of the terminal, no 4-step random access is configured on the first BWP, or a random access failure occurs, where the target configuration includes at least one of the following: a random access channel RACH resource or a monitoring configuration for a downlink channel; and
the first operation includes:
switching to the second BWP; or
initiating random access or monitoring the downlink channel on the second BWP; or
on the first BWP, performing a 4-step random access procedure or monitoring a downlink channel corresponding to the 4-step random access procedure, where the first condition is that the target configuration on the first BWP does not match the capability of the terminal.

Optionally, that a target configuration does not match a capability of the terminal includes:
the target configuration exceeds the capability of the terminal; or
the target configuration exceeds capabilities of some terminals of a terminal type, where the terminal type is a terminal type to which the terminal belongs.

Optionally, that the terminal performs the first operation includes:
the terminal performs the first operation in a case that a second condition is satisfied, where the second condition includes at least one of the following:
2-step random access is configured on the second BWP;
a RACH resource corresponding to the 2-step random access configured on the second BWP matches the capability of the terminal;
4-step random access is configured on the second BWP;
a RACH resource corresponding to the 4-step random access configured on the second BWP matches the capability of the terminal; or
a monitoring configuration for the downlink channel that is configured on the second BWP matches the capability of the terminal; and
the first operation includes:
switching to the second BWP; or
initiating the random access or monitoring the downlink channel on the second BWP.

Optionally, that the 2-step random access is configured on the second BWP may include at least one of the following:
a 2-step random access type is configured on the second BWP;
the RACH resource corresponding to the 2-step random access is configured on the second BWP; or
a monitoring configuration for the downlink channel that corresponds to the 2-step random access is configured on the second BWP; or
that 4-step random access is configured on the second BWP includes at least one of the following:
a 4-step random access type is configured on the second BWP;
the RACH resource corresponding to the 4-step random access is configured on the second BWP; or
a monitoring configuration for the downlink channel that corresponds to the 4-step random access is configured on the second BWP.

Optionally, the processor 1110 or the radio frequency unit 1101 is further configured to perform a second operation in a case that the first BWP satisfies the first condition and the second BWP does not satisfy the second condition, where the second operation includes:
switching to a third BWP; or
initiating a RACH procedure or monitoring the downlink channel on the third BWP.

Optionally, the second BWP includes an additional initial BWP; or
the third BWP includes an initial BWP.

Optionally, the third BWP satisfies a third condition, and the third condition includes:
the 2-step random access is configured on the third BWP;
a RACH resource corresponding to the 2-step random access configured on the third BWP matches the capability of the terminal;
the 4-step random access is configured on the third BWP;
a RACH resource corresponding to the 4-step random access configured on the third BWP matches the capability of the terminal; and
a monitoring configuration for the downlink channel that is configured on the third BWP matches the capability of the terminal.

Optionally, the first BWP includes at least one of the following: a first uplink BWP or a first downlink BWP; or
the third BWP includes at least one of the following: a third uplink BWP or a third downlink BWP; or
the switching to a third BWP includes at least one of the following:
switching to the third uplink BWP; or
switching to the third downlink BWP.

Optionally, the first BWP includes at least one of the following: a first uplink BWP or a first downlink BWP; or
the second BWP includes at least one of the following: a second uplink BWP or a second downlink BWP; or
the switching to a second BWP includes at least one of the following:
switching to the second uplink BWP; or
switching to the second downlink BWP.

Optionally, the RACH resource includes at least one of the following:
the RACH resource corresponding to the 2-step random access; or
the RACH resource corresponding to the 4-step random access.

Optionally, the performing a 4-step random access procedure on the first BWP includes:
in a case that the RACH resource includes the RACH resource corresponding to the 2-step random access and the 4-step random access is configured on the first BWP, performing, by the terminal, the 4-step random access procedure on the first BWP; or
the monitoring, on the first BWP, a downlink channel corresponding to the 4-step random access procedure includes:
in a case that the monitoring configuration for the downlink channel is the monitoring configuration for the downlink channel that corresponds to the 2-step random access and a monitoring configuration for the downlink channel that corresponds to the 4-step random access is configured on the first BWP, monitoring, on the first BWP, the downlink channel corresponding to the 4-step random access.

Optionally, the radio frequency unit 1101 is further configured to obtain configuration information, where the configuration information is used for configuring at least one of the following:
configuring the 2-step random access and the 4-step random access on the first BWP;
configuring, on the first BWP, the RACH resource corresponding to the 2-step random access and the RACH resource corresponding to the 4-step random access; or
configuring, on the first BWP, the monitoring configuration for the downlink channel that corresponds to the 2-step random access and the monitoring configuration for the downlink channel that corresponds to the 4-step random access.

Optionally, the RACH resource corresponding to the 4-step random access configured on the first BWP matches the capability of the terminal; or
the monitoring configuration for the downlink channel that corresponds to the 4-step random access configured on the first BWP matches the capability of the terminal.

Optionally, the capability of the terminal includes at least one of the following: a radio frequency RF bandwidth, a baseband bandwidth, an operating bandwidth, or a quantity of antennas.

Optionally, the first BWP includes at least one of the following:
an active BWP, a configured BWP, a deactivated BWP, an additional initial BWP, a BWP including a cell defining synchronization signal block CD-SSB, a BWP including a non-cell defining synchronization signal block NCD-SSB, a BWP including a control resource set CORESET #0, a first preset BWP, a default BWP, a fallback BWP, a BWP on which the RACH resource corresponding to the 4-step random access is configured, a BWP on which the RACH resource corresponding to the 2-step random access is configured, or a BWP on which a third operation is performed, where the third operation includes at least one of the following:
receiving a system information SI, monitoring paging, monitoring a paging early indication PEI, receiving an SSB, random access, measuring a CD-SSB, cell selection, cell reselection, camping, or small data transmission SDT.

Optionally, the second BWP includes at least one of the following:
an initial BWP, an additional initial BWP, a BWP including a CD-SSB, a BWP including an NCD-SSB, a BWP including a CORESET #0, a second preset BWP, a default BWP, a backoff BWP, a BWP on which the RACH resource corresponding to the 4-step random access is configured, a BWP on which the RACH resource corresponding to the 2-step random access is configured, or a BWP on which a fourth operation is performed, where the fourth operation includes at least one of the following:
receiving a system information SI, monitoring paging, monitoring a paging early indication PEI, receiving an SSB, random access, measuring a CD-SSB, cell selection, cell reselection, camping, or small data transmission SDT.

Optionally, in a case that the terminal switches to the second BWP or the terminal initiates the RACH procedure on the second BWP, the terminal performs at least one of the following for the second BWP:
in a case that the 2-step random access is configured on the second BWP, selecting or performing the 2-step random access, or confirming that the 2-step random access is available;
in a case that the 4-step random access is configured on the second BWP, selecting or performing the 4-step random access, or confirming that the 4-step random access is available;
in a case that the 2-step random access and the 4-step random access are configured on the second BWP, selecting or performing the 2-step random access, or confirming that the 2-step random access is available; or in the case that the 2-step random access and the 4-step random access are configured on the second BWP, selecting or performing the 4-step random access, or confirming that the 4-step random access is available.

Optionally, the in a case that the 2-step random access is configured on the second BWP, selecting or performing the 2-step random access, or confirming that the 2-step random access is available includes:
in a case that the 2-step random access is configured on the second BWP and the RACH resource corresponding to the 2-step random access configured on the second BWP matches the capability of the terminal, selecting or performing the 2-step random access, or confirming that the 2-step random access is available;
or
the in a case that the 4-step random access is configured on the second BWP, selecting or performing the 4-step random access, or confirming that the 4-step random access is available includes:
in a case that the 4-step random access is configured on the second BWP and the RACH resource corresponding to the 4-step random access configured on the second BWP matches the capability of the terminal, selecting or performing the 4-step random access, or confirming that the 4-step random access is available; or
the in a case that the 2-step random access and the 4-step random access are configured on the second BWP, selecting or performing the 2-step random access, or confirming that the 2-step random access is available includes:
in a case that the 2-step random access and the 4-step random access are configured on the second BWP and the RACH resource corresponding to the 2-step random access configured on the second BWP matches the capability of the terminal, selecting or performing the 2-step random access, or confirming that the 2-step random access is available; or
the in the case that the 2-step random access and the 4-step random access are configured on the second BWP, selecting or performing the 4-step random access, or confirming that the 4-step random access is available includes:
in a case that the 2-step random access and the 4-step random access are configured on the second BWP and the RACH resource corresponding to the 2-step random access configured on the second BWP does not match the capability of the terminal, selecting or performing the 4-step random access, or confirming that the 4-step random access is available.

In another embodiment,
the processor 1110 or the radio frequency unit 1101 is configured to perform a target operation on a target BWP, where the target operation includes at least one of the following:
in a case that 2-step random access is configured on the target BWP, selecting or performing the 2-step random access, or confirming that the 2-step random access is available;
in a case that 4-step random access is configured on the target BWP, selecting or performing the 4-step random access, or confirming that the 4-step random access is available;
in a case that the 2-step random access and the 4-step random access are configured on the target BWP, selecting or performing the 2-step random access, or confirming that the 2-step random access is available; or in the case that the 2-step random access and the 4-step random access are configured on the target BWP, selecting or performing the 4-step random access, or confirming that the 4-step random access is available.

Optionally, the in a case that the 2-step random access is configured on the target BWP, selecting or performing the 2-step random access, or confirming that the 2-step random access is available includes:
in a case that the 2-step random access is configured on the target BWP and a RACH resource corresponding to the 2-step random access configured on the target BWP matches a capability of the terminal, selecting or performing the 2-step random access, or confirming that the 2-step random access is available;
or
the in a case that 4-step random access is configured on the target BWP, selecting or performing the 4-step random access, or confirming that the 4-step random access is available includes:
in a case that the 4-step random access is configured on the target BWP and a RACH resource corresponding to the 4-step random access configured on the target BWP matches the capability of the terminal, selecting or performing the 4-step random access, or confirming that the 4-step random access is available; or
the in a case that the 2-step random access and the 4-step random access are configured on the target BWP, selecting or performing the 2-step random access, or confirming that the 2-step random access is available includes:
in a case that the 2-step random access and the 4-step random access are configured on the target BWP and the RACH resource corresponding to the 2-step random access configured on the target BWP matches the capability of the terminal, selecting or performing the 2-step random access, or confirming that the 2-step random access is available; or
the in the case that the 2-step random access and the 4-step random access are configured on the target BWP, selecting or performing the 4-step random access, or confirming that the 4-step random access is available includes:
in a case that the 2-step random access and the 4-step random access are configured on the target BWP and the RACH resource corresponding to the 2-step random access configured on the target BWP does not match the capability of the terminal, selecting or performing the 4-step random access, or confirming that the 4-step random access is available.

The foregoing terminal can improve communication performance of the terminal.

It may be understood that, for implementation processes of various implementations mentioned in this embodiment, refer to related descriptions in method embodiments, and the same or corresponding technical effects are achieved. To avoid repetition, details are not described herein again.

An embodiment of this application further provides a network side device, including a processor and a communication interface. The communication interface is configured to send configuration information to a terminal, where the configuration information is used for, in a case that the network side configures 2-step random access on a first bandwidth part BWP, configuring 4-step random access for the first BWP; or configuration content that the configuration information is used for satisfies at least one of the following: a RACH resource corresponding to the 2-step random access configured on the first BWP matches a capability of the terminal; a monitoring configuration for a downlink channel that corresponds to the 2-step random access configured on the first BWP matches the capability of the terminal; a RACH resource corresponding to the 4-step random access configured on the first BWP matches the capability of the terminal; or a monitoring configuration for the downlink channel that corresponds to the 4-step random access configured on the first BWP matches the capability of the terminal.

An embodiment of this application further provides a network side device, including a processor and a communication interface, where the communication interface is coupled to the processor, and the processor is configured to run a program or instructions, to implement the steps in the method embodiments shown in FIG. 5. The network side device embodiment corresponds to the foregoing network side device method embodiments. Both implementation processes and implementations of the foregoing method embodiments are applicable to the network side device embodiment, and the same technical effects can be achieved.

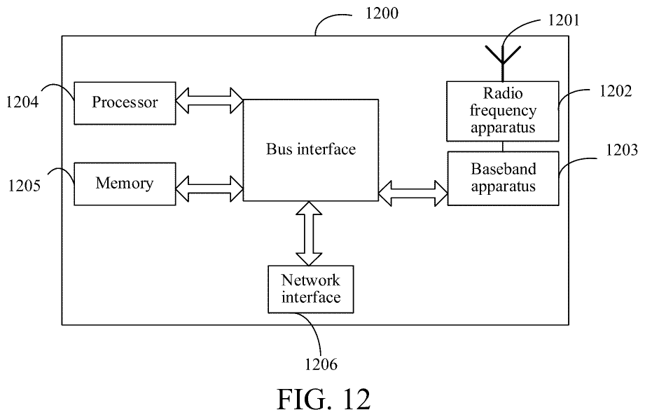

Specifically, an embodiment of this application further provides a network side device. As shown in FIG. 12, the network side device 1200 includes: an antenna 1201, a radio frequency apparatus 1202, a baseband apparatus 1203, a processor 1204, and a memory 1205. The antenna 1201 is connected to the radio frequency apparatus 1202. In an uplink direction, the radio frequency apparatus 1202 receives information through the antenna 1201, and sends the received information to the baseband apparatus 1203 for processing. In a downlink direction, the baseband apparatus 1203 processes information to be sent, and sends the processed information to the radio frequency apparatus 1202. The radio frequency apparatus 1202 processes the received information and then sends the processed information out through the antenna 1201.

The method performed by the network side device in the foregoing embodiments may be implemented in the baseband apparatus 1203. The baseband apparatus 1203 includes a baseband processor.

The baseband apparatus 1203 may include, for example, at least one baseband board. A plurality of chips are disposed on the baseband board. As shown in FIG. 12, one of the chips is, for example, the baseband processor, and is connected to the memory 1205 through a bus interface to invoke a program in the memory 1205, to perform an operation of a network device shown in the foregoing method embodiments.

The network side device may further include a network interface 1206. The interface is, for example, a common public radio interface (common public radio interface, CPRI).

Specifically, the network side device 1200 in this embodiment of this application further includes: instructions or a program stored in the memory 1205 and runnable on the processor 1204. The processor 1204 invokes the instructions or the program in the memory 1205 to perform the method performed by each module shown in FIG. 8, and achieves the same technical effects. To avoid repetition, details are not described herein again.

The radio frequency apparatus 1202 is configured to send configuration information to a terminal, where
the configuration information is used for, in a case that a network side configures 2-step random access on a first bandwidth part BWP, configuring 4-step random access for the first BWP; or
configuration content that the configuration information is used for satisfies at least one of the following:
a RACH resource corresponding to the 2-step random access configured on the first BWP matches a capability of the terminal;
a monitoring configuration for a downlink channel that corresponds to the 2-step random access configured on the first BWP matches the capability of the terminal;
a RACH resource corresponding to the 4-step random access configured on the first BWP matches the capability of the terminal; or
a monitoring configuration for the downlink channel that corresponds to the 4-step random access configured on the first BWP matches the capability of the terminal.

Optionally, that the 2-step random access is configured on the first BWP includes at least one of the following:
a 2-step random access type is configured on the first BWP;
the RACH resource corresponding to the 2-step random access is configured on the first BWP; or
the monitoring configuration for the downlink channel that corresponds to the 2-step random access is configured on the first BWP; or
that the 4-step random access is configured on the first BWP includes at least one of the following:
configuring a 4-step random access type on the first BWP;
the RACH resource corresponding to the 4-step random access is configured on the first BWP; or
the monitoring configuration for the downlink channel that corresponds to the 4-step random access is configured on the first BWP.

The foregoing network side device can improve communication performance of the terminal.

An embodiment of this application further provide a readable storage medium. The readable storage medium stores a program or instructions. The program or the instructions, when executed by a processor, implement processes in the foregoing embodiments of the switching method, the configuration method, and the random access processing method, and achieve the same technical effects. To avoid repetition, details are not described herein again.

The processor is the processor in the terminal in the foregoing embodiments. The readable storage medium includes a computer-readable storage medium, for example, a computer read-only memory ROM, a random access memory RAM, a magnetic disk, or an optical disc. In some examples, the readable storage medium may be a non-transitory readable storage medium.

An embodiment of this application further provides a chip, where the chip includes a processor and a communication interface, the communication interface is coupled to the processor, and the processor is configured to run a program or instructions to implement processes in the foregoing embodiments of the switching method, the configuration method, and the random access processing method, and achieve the same technical effects. To avoid repetition, details are not described herein again.

It should be understood that the chip mentioned in this embodiment of this application may also be referred to as a system-on-chip, a system chip, a chip system, a system-on-a-chip, or the like.

An embodiment of this application further provides a computer program/a program product. The computer program/the program product is stored in a storage medium. The computer program/the program product is executed by at least one processor to implement processes in the foregoing embodiments of the switching method, the configuration method, and the random access processing method, and achieve the same technical effects. To avoid repetition, details are not described herein again.

An embodiment of this application further provides a wireless communication system, including a terminal and a network side device. The terminal may be configured to perform steps of the switching method or the random access processing method according to embodiments of this application, and the network side device may be configured to perform steps of the configuration method according to embodiments of this application.

It should be noted that in this specification, the term “include”, “comprise”, or any other variants thereof are intended to encompass in a non-exclusive mode, so that a process, a method, an object, or an apparatus including a series of elements not only includes those elements, but also includes other elements that are not explicitly listed, or elements that are inherent to such a process, a method, an object, or an apparatus. Without more limitations, an element defined by a sentence “including one . . . ” does not exclude existence of other same elements in the process, the method, the object, or the apparatus that includes the element. In addition, it should be noted that a scope of the method and the apparatus in the implementations of this application is not limited to performing functions according to a sequence that is shown or discussed, but may further include performing functions in a substantially simultaneous manner or in a reversed sequence according to the functions involved. For example, the described method may be performed in a different order than a described order, and various steps may be added, omitted, or combined. In addition, features described with reference to some examples may be combined in other examples.

According to the descriptions in the foregoing implementations, a person skilled in the art can clearly learn that the method according to the foregoing embodiment may be implemented by relying on a computer software product and a necessary general hardware platform, and of course, may alternatively be implemented by hardware. The computer software product is stored in a storage medium (such as a ROM, a RAM, a magnetic disk, or an optical disc) and includes several instructions to enable a terminal or a network side device to perform the methods described in embodiments of this application.

The embodiments of this application are described above with reference to the accompanying drawings. However, this application is not limited to the specific implementations described above, and the specific implementations described above are only exemplary and not limitative. A person of ordinary skill in the art may make various variations of implementations under the teaching of this application without departing from the spirit of this application and the protection scope of the claims, and such implementations shall all fall within the protection scope of this application.

What is claimed is:

1. A switching method, wherein the method comprises:
performing, by a terminal, a first operation in a case that a first bandwidth part BWP satisfies a first condition, wherein the first condition comprises at least one of the following: a target configuration on the first BWP does not match a capability of the terminal, no 4-step random access is configured on the first BWP, or a random access failure occurs, wherein the target configuration comprises at least one of the following: a random access channel RACH resource or a monitoring configuration for a downlink channel; and
the first operation comprises:
switching to a second BWP; or
initiating random access or monitoring the downlink channel on the second BWP; or
on the first BWP, performing a 4-step random access procedure or monitoring a downlink channel corresponding to the 4-step random access procedure, wherein the first condition is that the target configuration on the first BWP does not match the capability of the terminal.

2. The method according to claim 1, wherein that the target configuration does not match the capability of the terminal comprises:
the target configuration exceeds the capability of the terminal; or
the target configuration exceeds capabilities of some terminals of a terminal type, wherein the terminal type is a terminal type to which the terminal belongs.

3. The method according to claim 1, wherein the performing, by a terminal, a first operation comprises:
performing, by the terminal, the first operation in a case that a second condition is satisfied, wherein the second condition comprises at least one of the following:
2-step random access is configured on the second BWP;
a RACH resource corresponding to the 2-step random access configured on the second BWP matches the capability of the terminal;
4-step random access is configured on the second BWP;
a RACH resource corresponding to the 4-step random access configured on the second BWP matches the capability of the terminal; or
a monitoring configuration for the downlink channel that is configured on the second BWP matches the capability of the terminal; and
the first operation comprises:
switching to a second BWP; or
initiating random access or monitoring the downlink channel on the second BWP.

4. The method according to claim 3, wherein that 2-step random access is configured on the second BWP comprises at least one of the following:
a 2-step random access type is configured on the second BWP;
the RACH resource corresponding to the 2-step random access is configured on the second BWP; or
a monitoring configuration for the downlink channel that corresponds to the 2-step random access is configured on the second BWP; or
that 4-step random access is configured on the second BWP comprises at least one of the following:
a 4-step random access type is configured on the second BWP;
the RACH resource corresponding to the 4-step random access is configured on the second BWP; or
a monitoring configuration for the downlink channel that corresponds to the 4-step random access is configured on the second BWP.

5. The method according to claim 3, wherein the method further comprises:
performing, by the terminal, a second operation in a case that the first BWP satisfies the first condition and the second BWP does not satisfy the second condition, wherein the second operation comprises:
switching to a third BWP; or
initiating a RACH procedure or monitoring the downlink channel on the third BWP.

6. The method according to claim 5, wherein the second BWP comprises an additional initial BWP; or
the third BWP comprises an initial BWP.

7. The method according to claim 5, wherein the third BWP satisfies a third condition, and third condition comprises:
the 2-step random access is configured on the third BWP;
a RACH resource corresponding to the 2-step random access configured on the third BWP matches the capability of the terminal;
the 4-step random access is configured on the third BWP;
a RACH resource corresponding to the 4-step random access configured on the third BWP matches the capability of the terminal; and
a monitoring configuration for the downlink channel that is configured on the third BWP matches the capability of the terminal.

8. The method according to claim 5, wherein the first BWP comprises at least one of the following: a first uplink BWP or a first downlink BWP; or
the third BWP comprises at least one of the following: a third uplink BWP or a third downlink BWP; or
the switching to a third BWP comprises at least one of the following:
switching to the third uplink BWP; or
switching to the third downlink BWP.

9. The method according to claim 1, wherein the first BWP comprises at least one of the following: a first uplink BWP or a first downlink BWP; or
the second BWP comprises at least one of the following: a second uplink BWP or a second downlink BWP; or
the switching to a second BWP comprises at least one of the following:
switching to the second uplink BWP; or
switching to the second downlink BWP.

10. The method according to claim 1, wherein the RACH resource comprises at least one of the following:
the RACH resource corresponding to the 2-step random access; or
the RACH resource corresponding to the 4-step random access.

11. The method according to claim 10, wherein the performing a 4-step random access procedure on the first BWP comprises:
in a case that the RACH resource comprises the RACH resource corresponding to the 2-step random access and the 4-step random access is configured on the first BWP, performing, by the terminal, the 4-step random access procedure on the first BWP; or
the monitoring, on the first BWP, a downlink channel corresponding to the 4-step random access procedure comprises:
in a case that the monitoring configuration for the downlink channel is the monitoring configuration for the downlink channel that corresponds to the 2-step random access and a monitoring configuration for the downlink channel that corresponds to the 4-step random access is configured on the first BWP, monitoring, on the first BWP, the downlink channel corresponding to the 4-step random access procedure.

12. The method according to claim 11, further comprising:
obtaining, by the terminal, configuration information, wherein the configuration information is used for configuring at least one of the following:
configuring the 2-step random access and the 4-step random access on the first BWP;
configuring, on the first BWP, the RACH resource corresponding to the 2-step random access and the RACH resource corresponding to the 4-step random access; or
configuring, on the first BWP, the monitoring configuration for the downlink channel that corresponds to the 2-step random access and the monitoring configuration for the downlink channel that corresponds to the 4-step random access.

13. The method according to claim 11, wherein the RACH resource corresponding to the 4-step random access configured on the first BWP matches the capability of the terminal; or
the monitoring configuration for the downlink channel that corresponds to the 4-step random access configured on the first BWP matches the capability of the terminal.

14. The method according to claim 1, wherein the first BWP comprises at least one of the following:
an active BWP, a configured BWP, a deactivated BWP, an additional initial BWP, a BWP comprising a cell defining synchronization signal block CD-SSB, a BWP comprising a non-cell defining synchronization signal block NCD-SSB, a BWP comprising a control resource set CORESET #0, a first preset BWP, a default BWP, a fallback BWP, a BWP on which the RACH resource corresponding to the 4-step random access is configured, a BWP on which the RACH resource corresponding to the 2-step random access is configured, or a BWP on which a third operation is performed, wherein the third operation comprises at least one of the following:
receiving a system information SI, monitoring paging, monitoring a paging early indication PEI, receiving an SSB, random access, measuring a CD-SSB, cell selection, cell reselection, camping, or small data transmission SDT.

15. The method according to claim 1, wherein the second BWP comprises at least one of the following:
an initial BWP, an additional initial BWP, a BWP comprising a CD-SSB, a BWP comprising an NCD-SSB, a BWP comprising a CORESET #0, a second preset BWP, a default BWP, a backoff BWP, a BWP on which the RACH resource corresponding to the 4-step random access is configured, a BWP on which the RACH resource corresponding to the 2-step random access is configured, or a BWP on which a fourth operation is performed, wherein the fourth operation comprises at least one of the following:
receiving a system information SI, monitoring paging, monitoring a paging early indication PEI, receiving an SSB, random access, measuring a CD-SSB, cell selection, cell reselection, camping, or small data transmission SDT.

16. The method according to claim 1, wherein in a case that the terminal switches to the second BWP or the terminal initiates the RACH procedure on the second BWP, the terminal performs at least one of the following for the second BWP:
in a case that the 2-step random access is configured on the second BWP, selecting or performing the 2-step random access, or confirming that the 2-step random access is available;
in a case that the 4-step random access is configured on the second BWP, selecting or performing the 4-step random access, or confirming that the 4-step random access is available;
in a case that the 2-step random access and the 4-step random access are configured on the second BWP, selecting or performing the 2-step random access, or confirming that the 2-step random access is available; or in the case that the 2-step random access and the 4-step random access are configured on the second BWP, selecting or performing the 4-step random access, or confirming that the 4-step random access is available.

17. A configuration method, wherein the method comprises:
sending, by a network side device, configuration information to a terminal, wherein
the configuration information is used for, in a case that a network side configures 2-step random access on a first bandwidth part BWP, configuring 4-step random access for the first BWP; or
configuration content that the configuration information is used for satisfies at least one of the following:
a RACH resource corresponding to the 2-step random access configured on the first BWP matches a capability of the terminal;
a monitoring configuration for a downlink channel that corresponds to the 2-step random access configured on the first BWP matches the capability of the terminal;
a RACH resource corresponding to the 4-step random access configured on the first BWP matches the capability of the terminal; or
a monitoring configuration for the downlink channel that corresponds to the 4-step random access configured on the first BWP matches the capability of the terminal.

18. The method according to claim 17, wherein that the 2-step random access is configured on the first BWP comprises at least one of the following:
a 2-step random access type is configured on the first BWP;
the RACH resource corresponding to the 2-step random access is configured on the first BWP; or
the monitoring configuration for the downlink channel that corresponds to the 2-step random access is configured on the first BWP; or
that the 4-step random access is configured on the first BWP comprises at least one of the following:
a 4-step random access type is configured on the first BWP;
the RACH resource corresponding to the 4-step random access is configured on the first BWP; or
the monitoring configuration for the downlink channel that corresponds to the 4-step random access is configured on the first BWP.

19. A terminal, comprising a processor and a memory, wherein the memory stores a program or instructions runnable on the processor, and the program or the instructions, when executed by the processor, implement steps of a switching method, the switching method comprising:
performing, by a terminal, a first operation in a case that a first bandwidth part BWP satisfies a first condition, wherein the first condition comprises at least one of the following: a target configuration on the first BWP does not match a capability of the terminal, no 4-step random access is configured on the first BWP, or a random access failure occurs, wherein the target configuration comprises at least one of the following: a random access channel RACH resource or a monitoring configuration for a downlink channel; and
the first operation comprises:
switching to a second BWP; or
initiating random access or monitoring the downlink channel on the second BWP; or
on the first BWP, performing a 4-step random access procedure or monitoring a downlink channel corresponding to the 4-step random access procedure, wherein the first condition is that the target configuration on the first BWP does not match the capability of the terminal.

20. A network side device, comprising a processor and a memory, wherein the memory stores a program or instructions runnable on the processor, and the program or the instructions, when executed by the processor, implement steps of the configuration method according to claim 17.
